(19) United States
(12) Patent Application Publication
(10) Pub. No.: US 2011/0231686 A1
(43) Pub. Date: Sep. 22, 2011

(54) MANAGEMENT APPARATUS AND MANAGEMENT METHOD

(75) Inventors: Hiroko FUJII, Narashino (JP); Hideo OHATA, Fujisawa (JP); Masaki MURAOKA, Yokohama (JP); Hidetaka SASAKI, Yokohama (JP)

(73) Assignee: HITACHI, LTD., Tokyo (JP)

(21) Appl. No.: 12/788,754

(22) Filed: May 27, 2010

(30) Foreign Application Priority Data
Mar. 17, 2010 (JP) 2010-061203

(51) Int. Cl. G06F 1/32

(52) U.S. Cl. 713/324

(57) ABSTRACT

Power savings for a storage apparatus while preventing a drop in response performance is achieved. When the storage area supplied by the memory apparatus groups is not accessed by the host apparatus for a predetermined period, stop operation is performed for each of the memory apparatuses configuring the memory apparatus groups. The management apparatus groups, among the resources, resources with overlapping time zones for which the number of accesses by the application is zero, in the same group, and maps each of the groups to the memory apparatus groups respectively. At this time, if the number of accesses in each of the time zones of the groups of resources mapped to the memory apparatus groups exceeds the reference value of the memory apparatus groups, the group is divided into a plurality of groups and each of the plurality of groups is mapped to the memory apparatus groups.

### CROSS REFERENCES

This application relates to and claims priority from Japanese Patent Application No. 2010-61203, filed on Mar. 17, 2010, the entire disclosure of which is incorporated herein by reference.

The present invention relates to a management apparatus and management method and, for example, can be suitably applied to a management apparatus for managing power savings of storage apparatuses.

### BACKGROUND

Conventionally, a power saving technology for storage apparatuses that has been proposed is a technology for measuring the load of a storage apparatus and for controlling a power source of a controller for controlling access to a disk device according to the measurement result (refer to Japanese Published Unexamined Application No. 2007-102409, for example).

Another storage apparatus power saving technology is a ‘MAID (Massive Array of Idle Disks) function’ for stopping the drive rotation of a hard disk device with no I/O (Input/Output) for a fixed period of time. The ‘MAID function’ allows the power consumption of the storage apparatus to be reduced since it is possible to match a time for stopping I/O (access) to a logical volume defined in the storage apparatus with a time for stopping the hard disk drive group that configures the hard disk group (such as a RAID (Redundant Array of Inexpensive Disks) group or an HDP Pool) providing the logical volume.

Furthermore, conventionally, if the time for stopping inputs and outputs (I/O) with respect to certain resources of the same type (such as logical devices of a server, file systems or logical volumes and so on of a host server) is made to coincide with the time when the hard disk device group is stopped, the I/O from the host server are then concentrated in another hard disk device group. However, no consideration has hitherto been paid to the number of I/O in resources of the same type.

Thus, with a conventional storage apparatus power saving method, the storage apparatus response performance drops in time zones where access is concentrated, which poses a risk to business operations.

### SUMMARY

The present invention was conceived in view of the above and proposes a highly reliable management apparatus and management method for providing power savings for a storage apparatus while preventing a drop in response performance.

In order to solve the above problem, the present invention provides a management apparatus for managing storage apparatuses which are equipped with a plurality of memory apparatus groups each configured from one or more memory apparatuses of the same type, which provide a storage area supplied by the memory apparatus groups to a host apparatus and which, when the storage area supplied by the memory apparatus groups is not accessed by the host apparatus for a predetermined period, stop operation of each of the memory apparatuses configuring the memory apparatus groups, comprising an information collection unit for collecting information indicating a number of accesses, in each predetermined time zone, to each of a plurality of resources of the same type each having a periodic time zone in which the number of accesses by the host apparatus is zero; a response time in each of the time zones by the resources to an application installed on the host apparatus; and an association between the application and the resource; a grouping unit for grouping, among the resources, resources with overlapping time zones for which the number of accesses by the application is zero, in the same group; a mapping unit for mapping each of the groups to the memory apparatus groups respectively; a migration execution unit for controlling the storage apparatuses to migrate data between memory apparatus groups where necessary on the basis of the result of the mapping of the groups to the memory apparatus groups by the mapping unit; and a reference value calculation unit for configuring, for each of the memory apparatus groups, a maximum value for the number of accesses by the application to the resources mapped to the memory apparatus groups as a reference value of the memory apparatuses, on the basis of the number of accesses in each time zone by the application to each of the resources collected by the information collection unit, and a response time for each time zone for the response by the resources to the application, wherein, if the number of accesses in each of the time zones of the groups of resources mapped to the memory apparatus groups exceeds the reference value of the memory apparatus groups, the mapping unit divides the group into a plurality of groups and maps each of the plurality of groups to the memory apparatus groups.

Furthermore, the present invention provides a management method for managing storage apparatuses which are equipped with a plurality of memory apparatus groups each configured from one or more memory apparatuses of the same type, which provide a storage area supplied by the memory apparatus groups to a host apparatus and which, when the storage area supplied by the memory apparatus groups is not accessed by the host apparatus for a predetermined period, stop operation of each of the memory apparatuses configuring the memory apparatus groups, comprising a first step of collecting information indicating a number of accesses, in each predetermined time zone, to each of a plurality of resources of the same type each having a periodic time zone in which the number of accesses by the host apparatus is zero; a response time in each of the time zones by the resources to an application installed on the host apparatus; and an association between the application and the resource; a second step of configuring, for each of the memory apparatus groups, a maximum value for the number of accesses by the application to the resources mapped to the memory apparatus groups as a reference value of the memory apparatuses, on the basis of the number of accesses in each time zone by the application to each of the collected resources, and a response time for each time zone for the response by the resources to the application, and of grouping, among the resources, resources with overlapping time zones for which the number of accesses by the application is zero, in the same group; a third step of mapping each of the groups to the memory apparatus groups respectively; and a fourth step of controlling the storage apparatuses to migrate data between memory apparatus groups where necessary on the basis of the result of the mapping of the groups to the memory apparatus groups, wherein, in the third step, if the number of accesses in each of the time zones of the groups of resources mapped to the memory apparatus groups exceeds the reference value of the memory apparatus groups, the group is divided into a plurality of groups and each of the plurality of groups is mapped to the memory apparatus groups.

The present invention allows grouping to be performed which considers the number of times resources of the same type are accessed and therefore this grouping of resources can be performed to the extent that there is no bottleneck affecting response performance.

Thus, a highly reliable management apparatus and management method for providing power savings for a storage apparatus while preventing a drop in response performance can be realized.

### DESCRIPTION OF DRAWINGS

FIG. 1 is a block diagram showing the overall configuration of a computer system according to an embodiment of the present invention;

FIG. 2 is a conceptual view of a specific example relating to the configuration of the resources of the computer system and associations between the resources;

FIG. 3 is a block diagram showing a detailed configuration of storage management software;

FIG. 4 is a schematic diagram that schematically shows a configuration example of a grouping result display screen;

FIG. 5 is a schematic diagram that schematically shows a configuration example of a power consumption reference value configuration screen;

FIG. 6 is a schematic diagram that schematically shows a configuration example of a response time threshold configuration screen;

FIG. 7 is a conceptual view of the configuration of an application performance information table;

FIG. 8 is a conceptual view of the configuration of a logical volume performance information table;

FIG. 9 is a conceptual view of the configuration of an array group performance information table;

FIG. 10 is a conceptual view of the configuration of a device file/file system-logical volume association table;

FIG. 11 is a conceptual view of the configuration of a device file/file system/application association table;

FIG. 12 is a conceptual view of the configuration of a logical volume/array group association table;

FIG. 13 is a conceptual view of the configuration of an array group configuration information table;

FIG. 14 is a conceptual view of the configuration of a resource grouping configuration table;

FIG. 15 is a conceptual view of the configuration of a resource grouping performance information table;

FIG. 16 is a conceptual view of the configuration of a grouping result storage table;

FIG. 17 is a conceptual view of the configuration of a reference value storage table;

FIG. 18 is a conceptual view of the configuration of a reduction rate storage table;

FIG. 19 is a conceptual view of the configuration of a power consumption reference value storage table;

FIG. 20 is a conceptual view of the configuration of the response time threshold table;

FIG. 21 is a flowchart showing the processing routine for power saving processing;

FIG. 22 is a flowchart showing the processing routine for agent information collection processing;

FIG. 23A is a flowchart showing the processing routine for resource grouping processing;

FIG. 23B is a flowchart showing the processing routine for resource grouping processing;

FIG. 24 is a flowchart showing the processing routine for array group reference calculation processing;

FIG. 25 is a flowchart showing the processing routine for group/array group mapping processing;

FIG. 26 is a flowchart showing the processing routine for reduction rate calculation processing;

FIG. 27 is a flowchart showing the processing routine for grouping display processing; and

FIG. 28 is a flowchart showing the processing routine for migration control processing.

### DETAILED DESCRIPTION

An embodiment of the present invention is now explained in detail with reference to the attached drawings.

### (1) Configuration of the Computer System According to this Embodiment

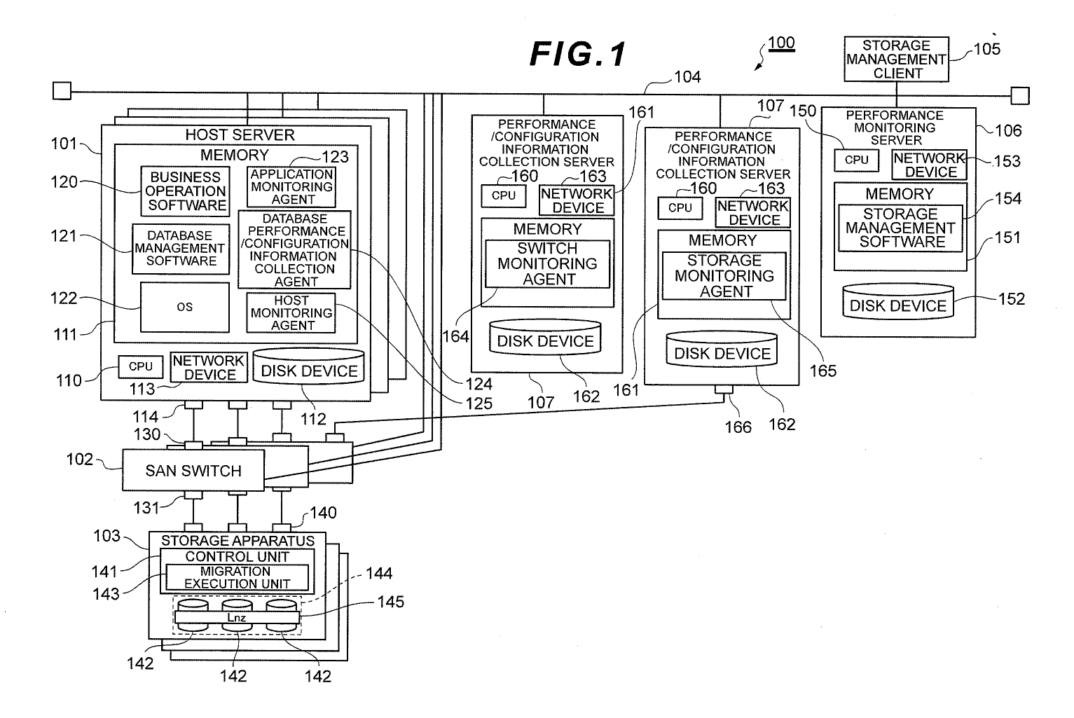

In FIG. 1, 100 denotes the overall computer system according to this embodiment. This computer system 100 is configured having a business operation system unit for performing business operation-related processing in a SAN (Storage Area Network) environment, and a storage management system for managing storage in a SAN environment.

The business operation system comprises, as hardware, one or more host servers 101, one or more SAN switches 102, one or more storage apparatuses 103, and a LAN (Local Area Network) 104, and comprises, as software, one or more business operation software 120 installed on the host server 101, and one or more database management software 121 similarly installed on the host server 101.

The host server 101 comprises a CPU (Central Processing Unit) 110, a memory 111, a hard disk device 112, and a network device 113.

The CPU 110 is a processor that executes a variety of software programs stored in the hard disk device 112 by reading these programs to the memory 111. In the following description, processing executed by the software programs thus read to the memory 111 is executed by the CPU 110 that actually executes these software programs.

The memory 111 is configured from a semiconductor memory such as a DRAM (Dynamic Random Access Memory) or the like, for example. The memory 111 stores various types of software that is executed by the CPU 110, and various types of information that the CPU 110 refers to. Specifically, the memory 111 stores software programs such as an OS (Operating System) 120, an application monitoring agent 123, a database performance/configuration information collection agent 124, and a host monitoring agent 125 or the like.

The hard disk device 112 is used to store various types of software and various types of information and so on. Note that a semiconductor memory such as flash memory or an optical disk device or the like, for example, may be adopted in place of the hard disk device 112.

The network device 113 is used by the host server 101 to communicate with the performance monitoring server 106 via the LAN 104 and to communicate with the storage apparatuses 103 via the SAN switches 102. The network device 113 comprises ports 1′14 that serve as communication cable connection terminals. In the case of this embodiment, the inputting and outputting of data from the host server 101 to the storage apparatuses 103 is performed in accordance with the fibre channel (FC: Fibre Channel) protocol but may also be performed using a different protocol. Furthermore, for the communications between the host server 101 and the storage apparatuses 103, the LAN 104 may also be used instead of using the network device 113 and the SAN switches 102.

The SAN switches 102 comprise one or more host ports 130 and storage ports 131 respectively, and the data access route between the host server 101 and the storage apparatuses 103 is configured by switching the coupling between the host ports 130 and the storage ports 131.

The storage apparatuses 103 have a built-in MAID function and are configured comprising one or more ports 140, a control unit 141, and a plurality of memory apparatuses 142, respectively.

The ports 140 are used to communicate with the host server 101 or the performance/configuration information collection servers 107 via the SAN switches 102.

The memory apparatuses are configured from costly disks such as SSD (Solid State Drive), SAS (Serial Attached SCSI) disks and low-cost disks such as SATA (Serial AT Attachment) disks or the like, for example. Note that, in addition to or rather than using SSD, SAS disks and SATA disks as the memory apparatuses 142, SCSI (Small Computer System Interface) disks or optical disk devices and so on, for example, may also be adopted.

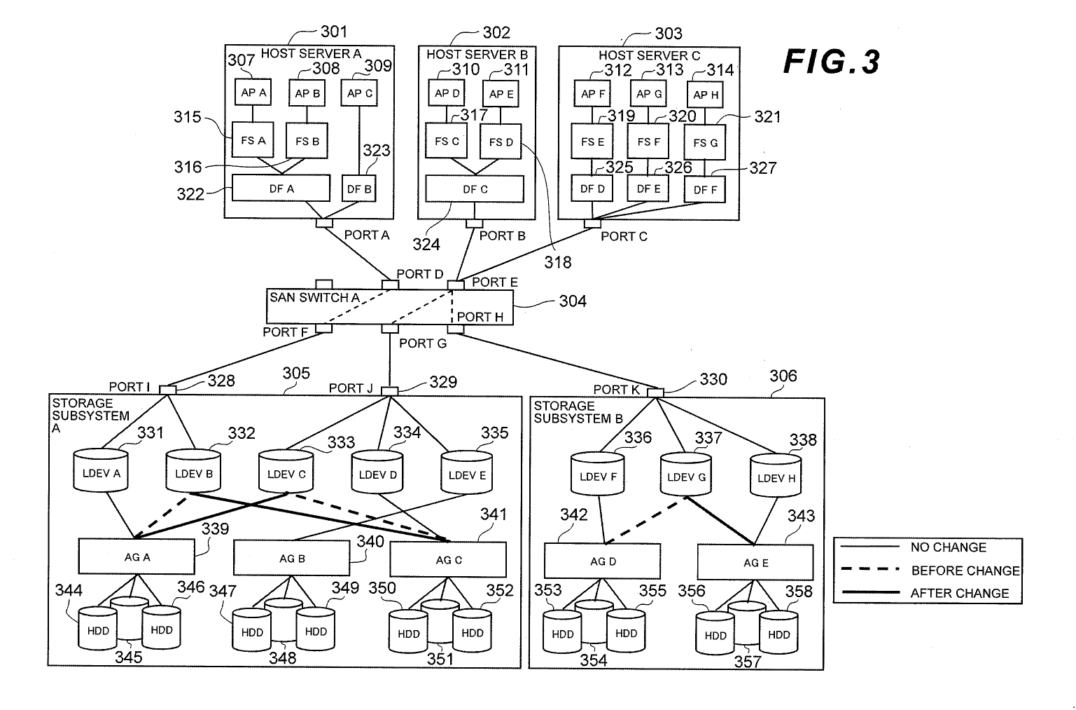

One or more the array groups 144 are formed by one or more memory apparatuses 142 of the same type (SSD, SAS disks or SATA disks or the like), and one or more logical volumes 145 are formed in a storage area provided by one array group 144. Furthermore, data from the host server 101 is read and written from and to the logical volumes 145. The relationships between the memory apparatuses 142, the array groups 144, and the logical volumes 145 will be described subsequently (refer to FIG. 3).

The control unit 141 is configured comprising hardware resources such as a processor and memory, and controls the operation of the storage apparatuses 103. For example, the control unit 141 controls the reading and writing of data with respect to the memory apparatuses 142 in accordance with I/O requests sent from the host server 101.

In addition, the control unit 141 monitors the access status of access by the host server 101 with respect to each logical volume 145, and if there is no access for a predetermined period with respect to any of the logical volumes 145 provided by a certain array group 144, sets that array group 144 (that is, each memory apparatus 142 configuring the array group 144) to a stopped operation status and if there is access by the host server 101 with respect to the logical volume 145 provided by the array group 144, starts up the array group 144 (that is, each memory apparatus 142 that configures the array group 144).

Furthermore, the control unit 141 comprises a migration execution unit 143 as software. The migration execution unit 143 executes migration processing for migrating data between array groups 144 (described subsequently) by controlling the corresponding memory apparatuses 142 upon receiving a migration command from the performance monitoring server 106.

The business operation software 120 and the database management software 121 is application software that provides a business operation logic function of the business operation system. The business operation software 120 and the database management software 121 execute inputting and outputting of data with respect to the storage apparatuses 103 where necessary. Note that, in the following description, the business operation software 120 will be suitably referred to as an “application.”

Access to the data in the storage apparatuses 103 by the business operation software 120 and the database management software 121 takes place via the OS 122, the network device 113, the ports 114, the SAN switches 102, and the ports 140 of the storage apparatuses 103.

The OS 122 is basic software of the host server 101 and provides a storage area that serves as the input/output destination of data with respect to the business operation software 120 and the database management software 121 in units referred to as files. The files managed by the OS 122 are associated by a mount operation with the logical volumes 145 managed by the OS 122 in units of a certain group (hereinafter called a file system). The files in the file system are in many cases managed using a tree structure.

Meanwhile, the storage management system comprises, as hardware, a storage management client 105, a performance monitoring server 106, one or more performance configuration information collection servers 107 and, as software, storage management software 154 installed on the performance monitoring server 106, a switch monitoring agent 164 and a storage monitoring agent 165 which are installed on the performance configuration information collection servers 107, and an application monitoring agent 123, a database performance configuration information collection agent 124 and a host monitoring agent 125 which are installed on the host server 101.

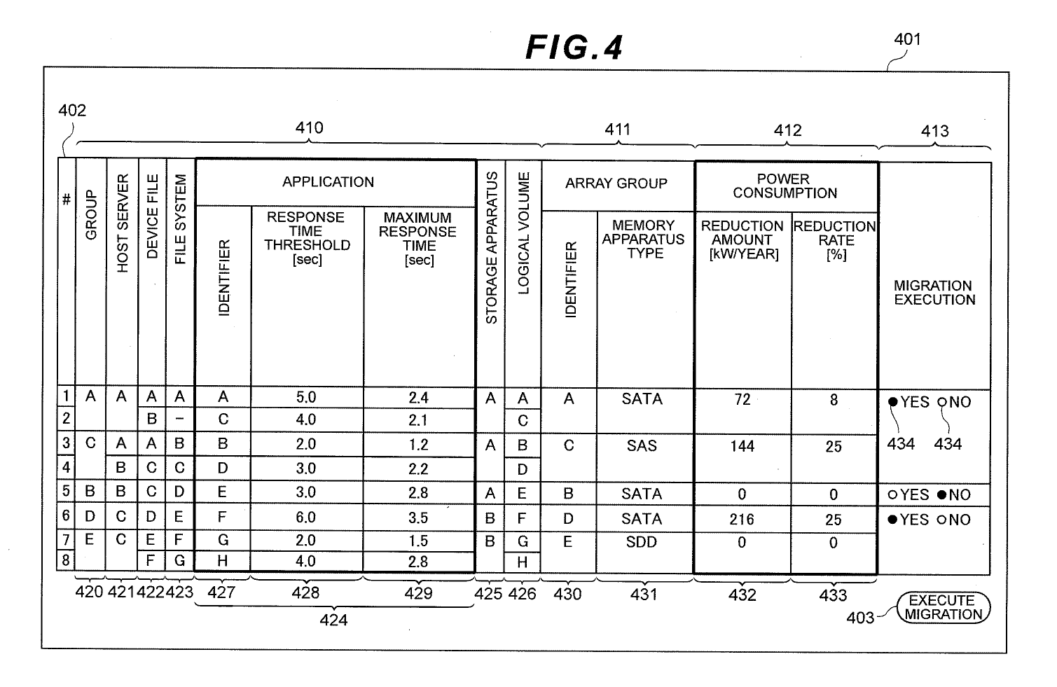

The storage management client 105 is an apparatus for providing a user interface function of the storage management software 154. The storage management client 105 comprises at least an input device for receiving inputs from the user and a display device (not shown) for displaying information to the user. The display device is configured from a CRT (Cathode Ray Tube) or a liquid-crystal display device and so on, for example. A configuration example of a GUI (Graphical User Interface) screen that is displayed on the display device will be described subsequently (FIGS. 4 to 6). The storage management client 105 communicates with the storage management software 154 of the performance monitoring server 106 via the LAN 104.

The performance monitoring server 106 comprises a CPU 150, a memory 151, a hard disk device 152, and a network device 153.

The CPU 150 is a processor that executes the software programs stored in the hard disk device 152 by reading these programs to the memory 151. In the following description, the processing executed by the software program read to the memory 151 is executed by the CPU 150 that actually executes the software program.

The memory 151 is configured from a semiconductor memory such as DRAM, for example. The memory 151 stores software programs that are read from the hard disk device 152 and executed by the CPU 150, and information that the CPU 150 refers to, and so forth. Specifically, the memory 151 stores at least the storage management software 154.

The hard disk device 152 is used to store various types of software and information and so on. Note that a semiconductor memory such as flash memory or an optical disk device or the like, for example, may be adopted in place of the hard disk device 152.

The network device 153 is used to allow the performance monitoring server 106 to communicate with the storage management client 105, the performance/configuration information collection servers 107 and the host server 101 and so forth via the LAN 104.

The performance/configuration information collection servers 107 comprise a CPU 160, a memory 161, a hard disk device 162, and a network device 163.

The CPU 160 is a processor that executes the software programs stored in the hard disk device 162 by reading these programs to the memory 161. In the following description, the processing that is executed by the software programs read to the memory 161 is executed by the CPU 160 that actually executes these software programs.

The memory 161 is configured from semiconductor memory such as DRAM, for example. The memory 161 stores software programs that are read from the hard disk device 162 and executed by the CPU 160 as well as data that the CPU 160 refers to, and so forth. Specifically, the memory 161 stores at least either the switch monitoring agent 164 or the storage monitoring agent 165.

The hard disk device 162 is used to store various types of software and data and so forth. Note that a semiconductor memory such as flash memory or an optical disk device or the like, for example, may also be used in place of the hard disk device 162.

The network device 163 is used to allow the performance/configuration information collection servers 107 to communicate with the performance monitoring server 106, or with the SAN switches 102 and storage apparatuses 103 that are the monitoring targets of the switch monitoring agent 164 and the storage monitoring agent 165 that are installed on the performance/configuration information collection servers 107 via the LAN 104.

The storage management software 154 is software that provides a function for collecting and monitoring SAN configuration information, performance information and application information. The storage management software 154 acquires the configuration information, performance information and application information from the hardware and software that form the SAN environment and therefore employ dedicated agent software, respectively.

The switch monitoring agent 164 is software for collecting performance information and configuration information that are required from the SAN switches 102 via the network device 163 and the LAN 104. In FIG. 1, the configuration is such that the switch monitoring agent 164 is made to run on a dedicated performance/configuration information collection server 107 but the switch monitoring agent 164 may also be made to run on the performance/configuration information collection server 107 where the performance monitoring server 106 and the storage monitoring agent 165 are installed.

The storage monitoring agent 165 is software for collecting the required performance information and configuration information from the storage apparatuses 103 by way of a port 166 of the network device 163 and the SAN switch 102. In FIG. 1, the configuration is such that the storage monitoring agent 165 is mounted on a dedicated performance/configuration information collection server 107 but may also be made to run on the performance monitoring server 106. Moreover, the configuration may also be such that a route passing via the LAN 104 is used as the communication route to the storage apparatus 103 instead of the route via the SAN switches 102.

The application monitoring agent 123 is software for collecting various performance information and configuration information relating to the business operation software 120, and the database performance/configuration information collection agent 124 is software for collecting various performance information and configuration information relating to the database management software 121. Furthermore, the host monitoring agent 125 is software for collecting required information relating to the performance and configuration of the host server 101.

### (2) Configuration of the Storage Management Software

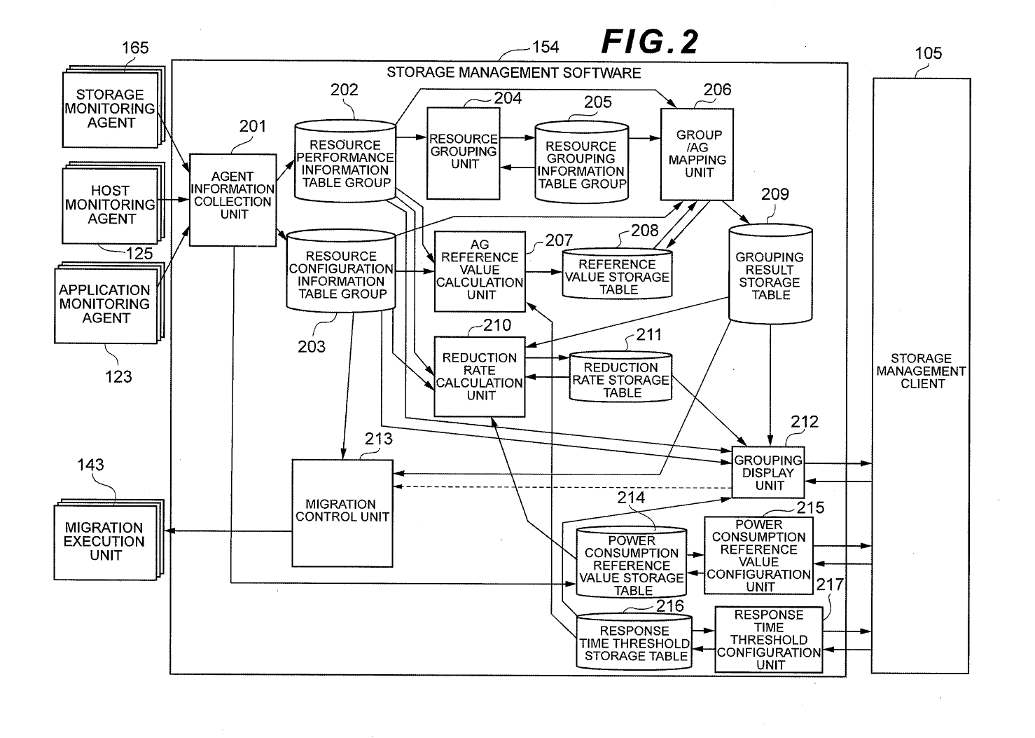

FIG. 2 shows a specific configuration of the storage management software 154. In FIG. 2, an agent information collection unit 201, a resource grouping unit 204, a group array group mapping unit 206, an array group reference value calculation unit 207, a reduction rate calculation unit 210, a grouping display unit 212, a migration control unit 213, a power consumption reference value configuration unit 215 and a response time threshold configuration unit 217 are program modules from which the storage management software 154 is configured.

Furthermore, in FIG. 2, a resource performance information table group 202, a resource configuration information table group 203, a resource grouping information table group 205, a reference value storage table 208, a grouping result storage table 209, a reduction rate storage table 211, a power consumption reference value storage table 214 and a response time threshold table 216 are tables that store various types of information managed by the storage management software 154 and are held in the memory 151 or the hard disk device 152 of the performance monitoring server 106.

The host monitoring agent 125 and the application monitoring agent 123 which are installed on the host server 101, and the storage monitoring agent 165 which is installed on the performance/configuration information collection server 107 are started up with predetermined timing (at regular intervals using a timer in accordance with scheduling settings, for example) or started up in response to a request from the storage management software 154 and these agents collect required performance information and/or configuration information from monitoring targets under the control of these agents.

The agent information collection unit 201 of the storage management software 154 is also started up with predetermined timing (at regular intervals in accordance with scheduling settings, for example) and collect performance information and configuration information of monitoring targets from the host monitoring agent 125, the application monitoring agent 123 and the storage monitoring agent 165 in the SAN environment. Furthermore, the agent information collection unit 201 stores the collected information in the resource performance information table group 202 and the resource configuration information table group 203.

Here, resources is a generic term for the hardware configuring the SAN environment (the storage apparatuses, the host server and so on) and the physical and logical components (array groups, logical volumes and the like), programs that are executed on the hardware (business operation software, database management software, file management systems, volume management software and the like) and logical components (file systems, logic devices and the like).

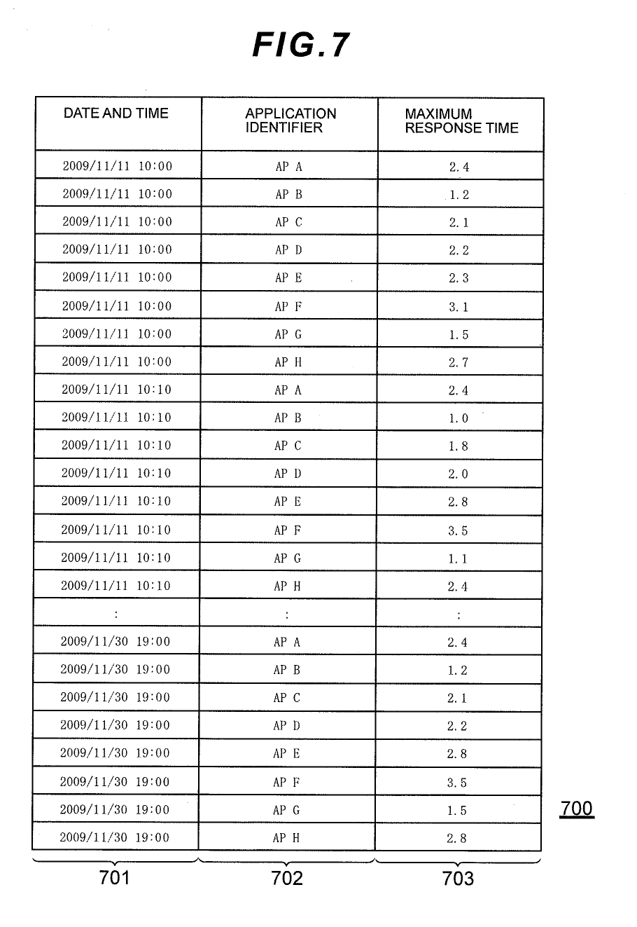

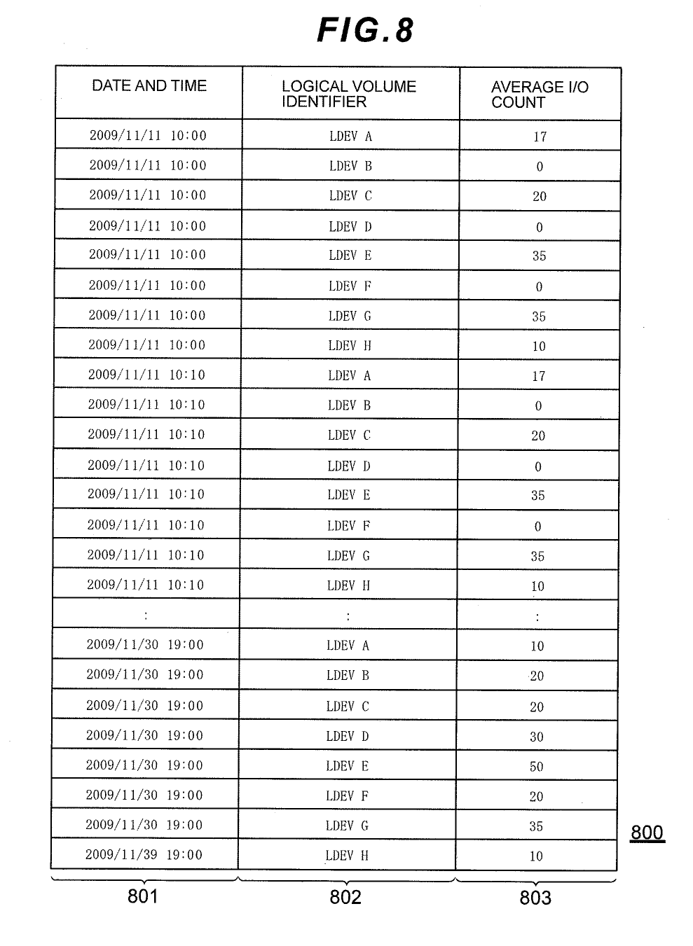

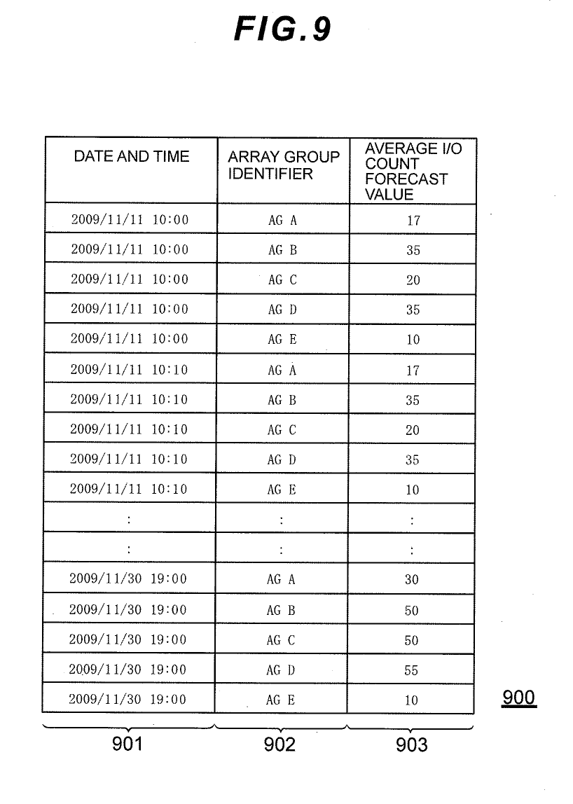

The resource performance information table group 202 may be broadly divided into tables for managing as is information collected by the agent information collection unit 201 from the storage monitoring agent 165, the host monitoring agent 125 and the application monitoring agent 123, and tables for managing information that is obtained by processing information collected by the agent information collection unit 201. The resource performance information table group 202 is configured from tables subsequently described in FIGS. 7 to 9, namely, an application performance information table 700 (FIG. 7), a logical volume performance information table 800 (FIG. 8) and an array group performance information table 900 (FIG. 9) where, of these tables, the application performance information table 700 and the logical volume performance information table 800 correspond to the former tables managing as is information collected by the agent information collection unit 201 and the array group performance information table 900 corresponds to the latter tables managing processed information.

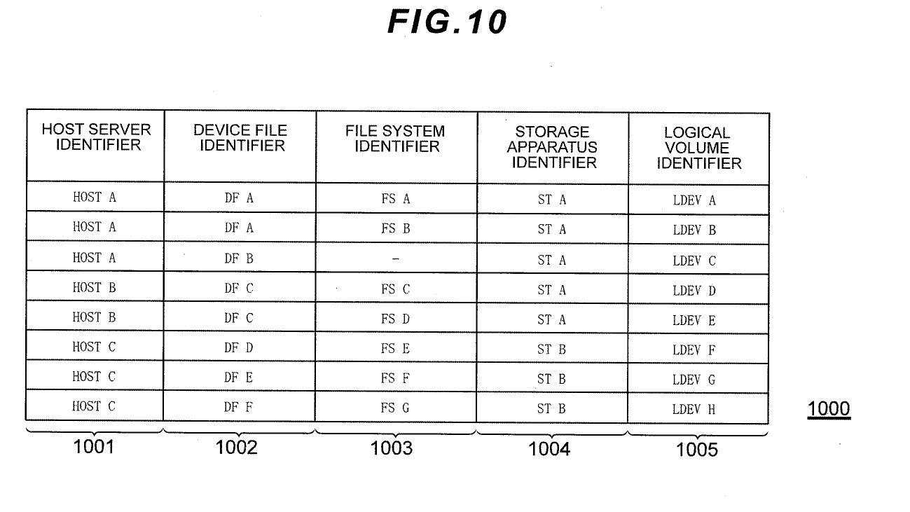

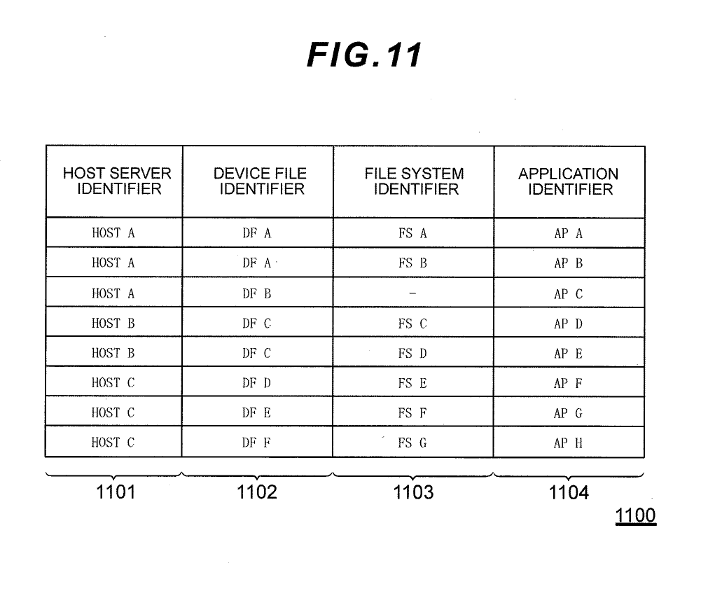

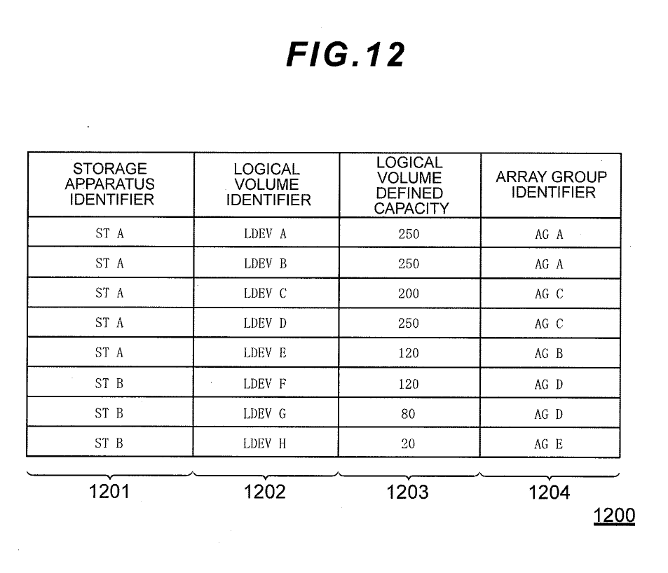

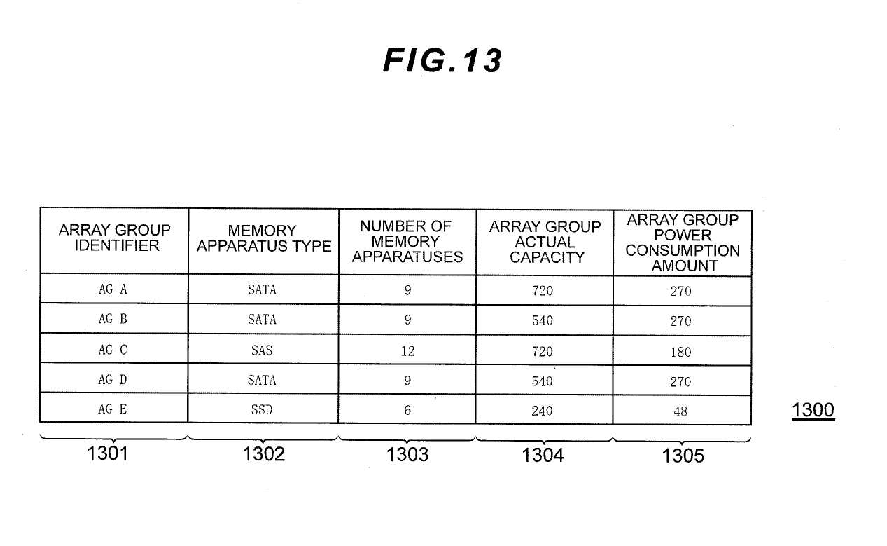

The resource configuration information table group 203 may also be broadly divided into tables for managing as is information collected by the agent information collection unit 201 from the storage monitoring agent 165, the host monitoring agent 125, and the application monitoring agent 123, and tables for managing information obtained by processing information collected by the agent information collection unit 201. The resource configuration information table group 203 is configured from tables that will be subsequently described in FIGS. 10 to 13, namely, a device file/file system-logical volume association table 1000 (FIG. 10), a device file/file system/application association table 1100 (FIG. 11), a logical volume/array group association table 1200 (FIG. 12) and an array group configuration information table 1301 (FIG. 13) where, of these tables, the device file/file system-logical volume association table 1000, device file/file system/application association table 1100, and the logical volume/array group association table 1200 correspond to the former tables for managing information as is and the array group configuration information table 1301 corresponds to the latter tables for managing processed information.

Meanwhile, the resource grouping unit 204 of the storage management software 154 groups logical volumes 145 with overlapping time zones for which the I/O count is ‘0’ into the same group on the basis of the average I/O. count in each predetermined time zone (for example, time zones for every 10 minutes) of each logical volume 145 (FIG. 1), as stored in the logical volume performance information table 800 (described subsequently), and stores the grouping result in the resource grouping information table group 205.

Furthermore, the array group reference value calculation unit 207 of the storage management software 154 acquires, respectively for each array group 144 (FIG. 1) on the basis of the resource grouping information table group 205, the average I/O count for each time zone from the logical volume performance information table 801 (FIG. 8) of the resource performance information table group 202 for each logical volume 145 associated with the array group 144. Note that a “logical volume associated with an array group” denotes each logical volume 145 formed in the storage area provided by the memory apparatuses 142 (FIG. 1) configuring the array group 144.

The array group reference value calculation unit 207 determines, for each array group 144, the I/O count of the time zone with the largest value in the total value of the I/O count for each time zone of each logical volume 145 associated with the array group 144, as a reference value of the array group 144 (referred to hereinbelow as the array group reference value), and stores the array group reference value of each array group 144 thus determined in the reference value storage table 208.

The group/array group mapping unit 206 of the storage management software 154 calculates, for each group of logical volumes 145 and on the basis of the resource grouping information table group 205, the total value for the defined capacity of each logical volume 145 belonging to the group. Furthermore, the group/array group mapping unit 206 performs mapping of array groups 144 to groups of logical volumes 145 on the basis of the actual capacity of each array group 144 obtained on the basis of the calculated value and the resource configuration information table group 203.

In addition, the group/array group mapping unit 206 divides these groups of logical volumes 145 if, as a result of mapping the groups with the array groups 144 on the basis of the actual capacity of the array groups 144 as mentioned earlier, a forecast value for the I/O count of a certain time zone of a certain group that is forecast on the basis of the average I/O. count for each time zone of the logical volumes 145 exceeds an array group reference value of the array group 144 associated with that group. Furthermore, the group/array group mapping unit 206 performs group integration if the number of groups of logical volumes 145 exceeds the number of array groups 144.

The reduction rate calculation unit 210 of the storage management software 134 calculates the current power consumption amount per year of all the memory apparatuses 142 on the basis of the current operating status of each array group 144, calculates the power consumption amount per year of all the memory apparatuses 142 after there has been a change to the group configuration of the logical volumes 145 as a result of this grouping and to the mapping of the array groups 144 to each group (referred to hereinafter as a configuration change), and stores the calculation results in the reduction rate storage table 211 respectively. Furthermore, the reduction rate calculation unit 210 calculates the power consumption reduction amount and the power consumption reduction rate per year of the memory apparatuses 142 overall on the basis of the power consumption amount per year before and after this configuration change, and stores the calculation results in the reduction rate storage table 211.

Meanwhile, the grouping display unit 212 of the storage management software 154 displays information such as the grouping result and the resulting power consumption reduction amount on the storage management client 105 on the basis of the grouping result storage table 209, the reduction rate storage table 211, and the subsequently described response time threshold table 216.

In addition, if the operating mode is preset to “automatic,” the migration control unit 213 of the storage management software 154 detects the difference between a new configuration following a configuration change that is identified from the grouping result storage table 209, and an pre-existing configuration prior to the configuration change. Furthermore, by controlling the migration execution unit 143 of the storage apparatus 103 on the basis of this detection result, the migration control unit 2131 migrates data stored in a corresponding logical volume 145 to another logical volume 145 in order to construct this new configuration.

In addition, if the operating mode has been set to “manual,” by controlling the migration execution unit 143 of the storage apparatus 103 in accordance with a migration command that corresponds to an operation by the user notified via the grouping display unit 212, and a the migration control unit 213 migrates data stored in the migration target logical volume 145 from a source array group 144 to a destination array group 144 in order to construct this new configuration. Furthermore, by controlling the migration execution unit 143, the migration control unit 213 reroutes the I/O path to the migrated logical volume 145 between array groups 144 in the storage apparatus 103 in accordance with the new configuration.

However, the power consumption reference value configuration unit 215 of the storage management software 154 stores, in the power consumption reference value storage table 214, an estimate value (referred to hereinafter as the power consumption reference value) for the power consumption amount per hour for each type of memory apparatus 142 (SSD, SATA, SAS, and the like) collected by the agent information collection unit 201 or set by the user via the storage management client 105. The power consumption reference values per hour for each type of memory apparatus stored in the power consumption reference value storage table 214 are used by the reduction in rate calculation unit 210 when calculating the power consumption amount per year before and after grouping as mentioned earlier.

In addition, the response time threshold configuration unit 217 of the storage management software 154 stores, and in the response time threshold table 216, the maximum value (referred to as the response time threshold hereinbelow) allowed as the response time from the corresponding logical volume 145 for each application installed on the host server 101 and set by the user via the storage management client 224. The response time threshold for each application stored in the response time threshold table 216 is used when the array group reference value calculation unit 207 calculates the array group reference value for each array group 144 as mentioned earlier.

### (3) Association Between Resource Configuration and Resources

FIG. 3 shows a specific example relating to the association between the resource configuration and resources in a SAN environment according to the present embodiment.

The SAN environment hardware shown in FIG. 3 is configured from three host servers 301 to 303, known as “host server A” to “host server C,” one SAN switch 304, known as “SAN switch A,” and two storage apparatuses 305, 306 known as “storage apparatus A” and “storage apparatus B.”

“Host server A” to “host server C” correspond to the host servers 101 in FIG. 1 respectively. “SAN switch A” corresponds to the SAN switch 102 in FIG. 1. In addition, the “storage apparatus A” and the “storage apparatus B” correspond to the storage apparatuses 103 in FIG. 1.

The applications 307 to 309 known as “AP A” to “AP C” run on the host server 301 called the “host server A,” the applications 310, 311 called “AP D” and “AP E” run on the host server 302 known as “host server B,” and applications 312 to 314, known as “AP E” to “AP G” run on the host server 303 called “host server C.” These applications 307 to 314 correspond to the business operation software 120 in FIG. 1, respectively.

Furthermore, file systems 315, 316, known as “FS A” and “FS B” and device files 322, 323, known as “DF A” and “DF B” are defined on the host server 301 known as “host server A”; file systems 317, 318, known as “FS C” and “FS D” and device file 324 known as “DF C” are defined on the host server 302 called “host server B”; and file systems 319 to 321, known as “FS E” to “FS G” and device files 325 to 327, known as “DF D” to “DF F” are defined for the host server 303 called “host server C.”

Running on these host servers 301 to 303 are the application monitoring agent 123 (FIG. 1) for collecting performance information and configuration information of the applications 307 to 314 installed on these same servers respectively, and the host monitoring agent 125 (FIG. 1) for collecting performance information and configuration information of the file systems 315 to 321 and the device files 322 to 327 which are defined on the same servers.

FIG. 3 displays lines linking resources. These lines indicate the data input/output (I/O)-dependent relationship between two resources that are connected by a line. For example, in FIG. 3, a line linking the application 307 known as “AP A” to the file system 315 “FS A” is shown, where this line shows an association whereby I/O requests are issued by the application 307 called “AP A” to the file system 315 known as “FS A.”

The line linking the file systems 315 and 316 called “FS A” and “FS B” to the device file 322 known as “DF A” indicates an association whereby the I/O load on these file systems 315, 316 is a read or write of the device file 322.

The narrow line representing “no change” in FIG. 3 denotes an association between a grouping of logical volumes 331 to 338 as described subsequently and unchanged parts before and after a configuration change corresponding to this grouping. Furthermore, the thick line representing “before change” in FIG. 3 indicates an association before a localized change that is made in the course of this configuration change. In addition, in FIG. 3, “after change” represents an association after a localized change that is made in the course of this configuration change.

Note that although omitted from FIG. 3, in order to acquire performance information and configuration information of storage apparatuses 305, 306, the storage monitoring agent 165 (FIG. 1) runs on the performance/configuration information collection server 107 (FIG. 1). The resources, which for the storage monitoring agent 165 are collection targets for performance information and configuration information, are at least logical volumes 331 to 338 known as “LDEV A” to “LDEV H” defined in each of the storage apparatuses 305, 306 as well as the array groups 339 to 343 known as “AG A” to “AG E” and defined in the storage apparatuses 305, 306.

In the array groups 339 to 343 are logical disk drives configured from one or more memory apparatuses 344 to 358 of the same type depending on the functions of the control unit 141 (FIG. 1) of the corresponding storage apparatuses 305, 306 respectively. These array groups 339 to 343 correspond to the array groups 144 in FIG. 1 and memory apparatuses 344 to 358 correspond to the memory apparatuses 142 in FIG. 1.

Furthermore, logical volumes 331 to 338 are logical disk drives formed as a result of the function of the control unit 141 of the storage apparatuses 305, 306 dividing up the array groups 339 to 342 within the same apparatuses according to a designated size. These logical volumes 331 to 338 correspond to the logical volumes 145 in FIG. 1. The control unit 141 secures, during creation of the logical volumes 331 to 338 and in the corresponding array groups 339 to 343, the corresponding amount of storage area of the defined capacity of these logical volumes 331 to 338.

Each of the device files 322 to 327 of the host servers 301 to 303 is allocated to any of the logical volumes 331 to 338 of the storage apparatuses 305, 306 respectively. The configuration information representing the correspondence relationship between the device files 322 to 327 and the logical volumes 331 to 338 is collected by the host monitoring agent 125 (FIG. 1).

As described hereinabove, when association information between resources reaching the logical volumes 331 to 338 from the applications 307 to 314 via the file systems 315 to 321 and the device files 322 to 327 is correlated, a so-called I/O route is obtained.

For example, when the application 314 known as “AP H” issues an I/O request to the file system 321 known as “FS G,” the file system 321 is secured in the device file 327 known as “DF F” and the device file 327 is allocated to the logical volume 338 known as “LDEV H” and the logical volume 338 is allocated to the array group 343 known as “AG E.” In this case, the load of the I/O generated by the application 314 known as “AP H” arrives at the corresponding memory apparatuses 356 to 358 from the file system 321 known as “FS G” via a route that passes through the device file 327 known as “DF F,” the logical volume 338 known as “LDEV H,” and the array group 343 known as “AG E.”

### (4) Configuration of Each Screen

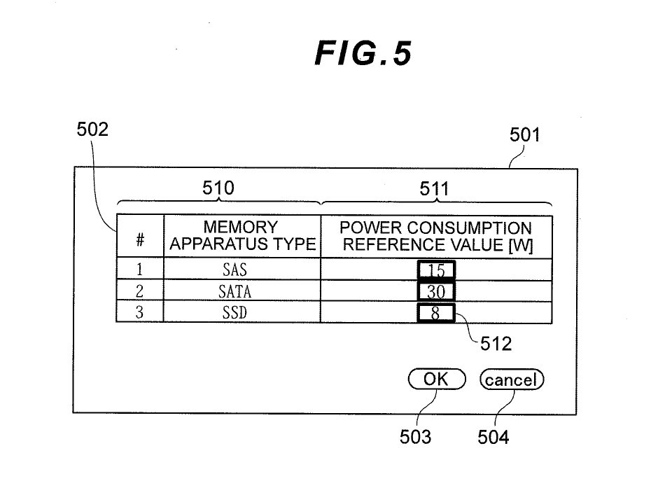

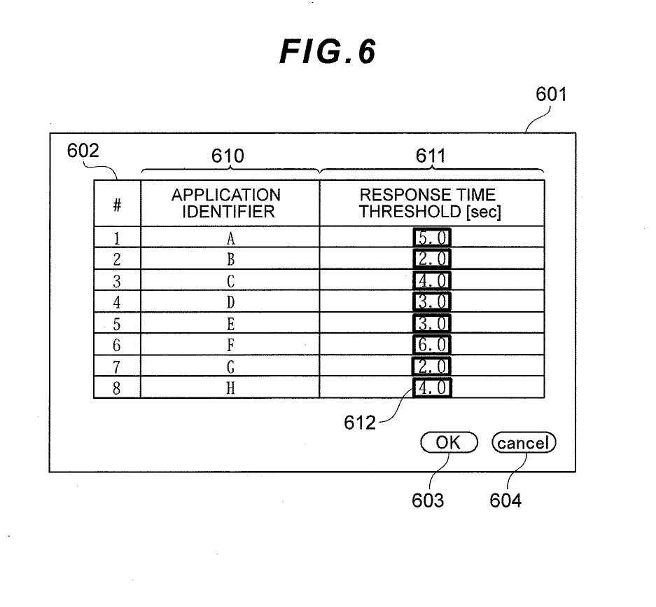

A configuration example of a GUI screen displayed on the display device of the storage management client 105 (FIG. 1) will be described next with reference to FIGS. 4 to 6. Specifically, FIG. 4 is a configuration example of the grouping result display screen 401 that is displayed on the display device of the storage management client 105 by the grouping display unit 212 (FIG. 2) of the storage management software 154 (FIG. 2), and FIGS. 5 and 6 are configuration examples of a power consumption reference value configuration screen 501 and a response time threshold configuration screen 601 that are displayed on this display device of the storage management client 105 by a function of the storage management client 105.

FIG. 4 shows a configuration example of the grouping result display screen 401. This grouping result display screen 401 is a GUI screen for displaying the processing results of the grouping processing of logical volumes 145 (FIG. 1) that is executed by the resource grouping unit 204 mentioned earlier with reference to FIG. 2, and the group/array group mapping processing that maps the array groups 144 to each group of new logical volumes 145 formed by this grouping processing and which mapping processing is executed by the group/array group mapping unit 206.

The grouping result display screen 401 is configured from a grouping result list 402 and a migration execution button 403. Furthermore, the grouping result list 402 is configured from a grouping configuration display area 410, an array group configuration display area 411, a power consumption display area 412, and a migration execution configuration area 413.

The grouping configuration display area 410 is configured from a group identifier field 420, a host server identifier field 421, a device file identifier field 422, a file system identifier field 423, an application field 424, a storage apparatus identifier field 425, and a logical volume identifier field 426. Furthermore, the application field 424 is configured from an identifier field 427, a response time threshold field 428, and a maximum response time field 429.

Furthermore, the group identifier field 420 displays an identifier (group identifier) that is assigned to each group of logical volumes 145 (FIG. 1) that is formed by the grouping processing of the resource grouping unit 204. In addition, the logical volume identifier field 426 stores an identifier (volume identifier) of each logical volume 145 belonging to the group in association with the group identifier respectively, and the storage apparatus identifier field 425 displays an identifier (storage apparatus identifier) of the storage apparatus 103 (FIG. 1) as defined by the corresponding logical volume 15.

In addition, the identifier field 427 of the application field 424, the response time threshold field 428 and the maximum response time field 429 display, in association with the logical volume identifier stored in the logical volume identifier field 426, the identifier (application identifier) of the application (business operation software 120) that uses the logical volume 145 to which this logical volume identifier has been assigned, a response time threshold that is configured for the application, and a maximum response time (described subsequently), respectively.

Furthermore, the host server identifier field 421 displays the identifier (host server identifier) of the host server 101 in which the corresponding application is installed, and the device file identifier field 422 and the file system identifier field 423 display the identifier of the device file (device file identifier) and the identifier of the file system (file system identifier) respectively which are associated with the corresponding application.

Meanwhile, the array group configuration display area 411 is configured from an identifier field 430 and a memory apparatus type field 431. Further, the identifier field 430 displays the identifier (array group identifier) of the array group 144 (FIG. 1) that is allocated to the group of logical volumes 145 to which the group identifier stored in the corresponding group identifier field 420 has been assigned, and the memory apparatus type field 431 displays the type (SSD, SAS, or SATA, or the like) of the memory apparatuses 142 configuring the array group 144.

Furthermore, the power consumption display area 412 is configured from a reduction amount field 432 and a reduction rate field 433. Furthermore, the reduction amount field 432 displays, in kilowatt (‘kW’) units, the reduction amounts of power consumption per year that is expected as a result of the configuration change to configure the corresponding group of logical volumes 145, and the reduction rate field 433 displays the reduction rate of power consumption per year that is expected as a result of a configuration change for configuring this group.

Furthermore, the migration execution configuration area 413 displays two radio buttons 434 for opting to change (“YES”) or not change (“NO”) the configuration of the corresponding groups that are displayed in the grouping results list 402 at this time. However, two radio buttons 434 are displayed as invalid for those groups which, as a result of the grouping, do not require the execution of a configuration change. In addition, two radio buttons 434 are displayed for opting, when a configuration change to a certain group will also affect another group, whether or not to execute a configuration change for this group as a whole (for example, the two groups “A” and “C” in FIG. 4).

The migration execution button 403 is a button for executing, if the operating mode of the storage management software 154 is “manual,” a change in configuration according to the processing results of the grouping processing that is triggered by an execution command from the user.

Thus, if the user desires to change, via the grouping result display screen 401, the configuration of a group displayed in the grouping result list 402 to the configuration displayed on the grouping result display screen 401 at the time, the user selects the radio button 434 corresponding to “YES” of the migration execution configuration area 413 corresponding to that group (the user clicks on the radio button 434 so that a black circle is displayed); however, if the user does not desire this group configuration change, the user selects the radio button 434 corresponding to “NO” of the migration execution configuration area 413 corresponding to that group and then, by clicking the migration execution button 403, is able to change the configuration of the desired group (in other words, the group to which the radio button 434 corresponding to “YES” is selected in the corresponding migration execution configuration area 413) to the configuration displayed in the grouping result list 402 at the time.

Meanwhile, FIG. 5 shows a configuration example of a power consumption reference value configuration screen 501 that is displayed on the display device of the storage management client 105 in accordance with an instruction from the power consumption reference value configuration unit 215 of the storage management software 154 (FIG. 2). The power consumption reference value configuration screen 501 is a screen, for configuring the power consumption amount per hour for each type of memory apparatus 142, that is used as mentioned earlier by the reduction rate calculation unit 21 (FIG. 1) when calculating the power consumption amount or the like per year of this memory apparatus 142, and is configured from a power consumption reference value configuration unit 502, an OK button 503, and a cancel button 504.

The power consumption reference value configuration unit 502 is configured from a memory apparatus type field 510 and a power consumption reference value field 511. Furthermore, the memory apparatus type field 510 displays all the types of memory apparatuses 142 (FIG. 1) mounted in the storage apparatus 103 respectively, these types being collected by the agent information collection unit 201 or configured by the user via the storage management client 105. Furthermore, the power consumption reference value field 511 displays the power consumption reference value input field 512 which the user uses to configure the power consumption amount (power consumption reference value) that is forecast when the corresponding type of memory apparatus 142 consumes power for one hour.

Thus, after using the power consumption reference value configuration screen 501 to input forecast values for the power consumption per hour pertaining to the memory apparatus types that respectively correspond to the power consumption reference value input fields 512 of the power consumption reference value fields 511 in the power consumption reference value configuration unit 502, the user is able to configure these numerical values as power consumption reference values for the corresponding types of memory apparatuses 142 by clicking the OK button 503. Furthermore, by clicking the Cancel button 504 via the power consumption reference value configuration screen 501, the user is able to close the power consumption reference value configuration screen 501 with updating the power consumption reference values of each of the memory apparatus types.

Meanwhile, FIG. 6 shows a configuration example of the response time threshold configuration screen 601 that is displayed on the storage management client 105 in accordance with an instruction from the response time threshold configuration unit 217 (FIG. 2) of the storage management software 154 (FIG. 2). The response time threshold configuration screen 601 is a screen for configuring the response time threshold of each application (business operation software 120) installed on the host server 101 (FIG. 1), and is configured from a response time threshold configuration unit 602, an OK button 603, and a Cancel button 604.

The response time threshold configuration unit 602 is configured from an application identifier field 610 and a response time threshold configuration field 611. Furthermore, the application identifier field 610 stores the identifiers of applications (application identifiers) installed on any host server 101. The response time threshold configuration field 611 displays a response time threshold input field 612 with which the user configures the response time threshold for the corresponding application.

Thus, after using the response time threshold configuration screen 601 to input the desired numerical values in the response time threshold input field 612 of each response time threshold configuration field 611 of the response time threshold configuration unit 602, the user is able to configure these numerical values as response time thresholds for the corresponding applications by clicking the OK button 603. In addition, by clicking the cancel button 604 on the response time threshold configuration screen 601, the user is able to close the response time threshold configuration screen 601 without updating the response time thresholds of each of the applications.

### (5) Configuration of Each Table

### (5-1) Configuration of the Resource Performance Information Table Group

An example of the configuration of the resource performance information table group 202 (FIG. 2) used by the storage management software 154 will be described next with reference to FIGS. 7 to 9.

The resource performance information table group 202 is configured from the application performance information table 700 (FIG. 7), the logical volume performance information table 800 (FIG. 8), and the array group performance information table 900 (FIG. 9).

The application performance information table 700 is a table that is used to hold and manage information relating to the performance of each application (business operation software 120) collected by the agent information collection unit 201 (FIG. 2) from the application monitoring agent 163 (FIG. 2) and, as shown in FIG. 7, is configured from a date and time field 701, an application identifier field 702 and a maximum response time field 703.

Furthermore, the date and time field 701 stores the date and time zone (time zone every 10 minutes in the example of FIG. 7) when the information was collected, and the application identifier field 702 stores the application identifier of the corresponding application. Furthermore, the maximum response time field 703 stores the average value of the maximum response times from the logical volumes 145 corresponding to the I/O from the application, for every predetermined time (every minute in the example of FIG. 7) in the corresponding time zone.

Accordingly, FIG. 7 shows that the average value of the maximum response times every minute for the application called “AP B” in the time zone “2009/11/11 10:00” to “2009/11/11 10:10” (that is, the average value of a total of 10 maximum response times acquired for each minute of the time zone “2009/11/11 10:00” to “2009/11/11 10:10”), for example, is “1.2” (refer to the second row in FIG. 7), and that the average value of the maximum response time for each minute of the time zone “2009/11/11 10:10” to “2009/11/11 10:20” of this application is “1.0” (refer to the tenth row in FIG. 7). Note that hereinafter the average value of the maximum response time for each minute of each application in each time zone will be called a maximum response time average value of the time zone.

Furthermore, the logical volume performance information table 800 is a table that is used to hold and manage information relating to the performance of each logical volume 145 created in the storage apparatus 103 and collected by the storage monitoring agent 165 (FIG. 2) and, as shown in FIG. 8, is configured from a date and time field 801, a logical volume identifier field 802, and an average I/O count field 803.

Furthermore, the date and time field 801 stores the date and time zone when the information was collected (time zones for every 10 minutes in the example of FIG. 8) and the logical volume identifier field 802 stores the identifier of the corresponding logical volume 145. Furthermore, the average I/O count field 803 stores the average value of the I/O count of the logical volume 145 for every predetermined time in the time zone (every minute in the example in FIG. 8). Note that hereinafter the average value of the I/O count every minute for each logical volume in each time zone will be called the average I/O count.

Therefore, FIG. 8 shows, for example, that the average I/O count for each minute of the logical volume 145 called “LDEV A” in the time zone “2009/11/11 10:00 to “2009/11/11 10:10” (specifically, the average value of a total of ten I/O counts acquired every minute in the time zone “2009/11/11 10:00 to “2009/11/11 10:10”) is “17” (refer to the first row in FIG. 8), and that the average I/O count for each minute in the time zone “2009/11/30 19:00” to “2009/11/40 19:00” of the logical volume 145 is “10” (refer to the eighth row from the bottom of FIG. 8).

The array group performance information table 900 is a table that is used to hold and manage information relating to the performance of each array group 144 that is defined in the storage apparatus 103 and collected by the storage monitoring agent 165 (FIG. 2) and, as shown in FIG. 9, is configured from a date and time field 901, an array group identifier field 902, and an average I/O count forecast value field 903.

In addition, the date and time field 901 stores a date and time zone when the information was collected (time zones for every 10 minutes in the example of FIG. 9) and the array group identifier field 902 stores the array group identifier of the corresponding array group 144. Furthermore, the average I/O count forecast value field 903 stores a forecast value for the average value of the I/O counts in the array group 144 for every predetermined time in the time zone (every minute in the example of FIG. 9). The forecast value is obtained by totaling up the average I/O counts of all the logical volumes 145 associated with the corresponding array group 144 (all the logical volumes 145 defined in the storage area provided by each memory apparatus 142 configuring the array group 144). Note that hereinafter the forecast value for the average value of the I/O counts for every minute of the array group 144 in each time zone will be called the average I/O count forecast value.

Hence, FIG. 9 shows, for example, that the average I/O count forecast value every minute in the array group 144 called “AG A” in the time zone “2009/11/11 10:00” to “2009/11/11 10:10” (specifically, the average value of a total of ten corresponding average I/O counts acquired every minute in the time zone “2009/11/11 10:00” to “2009/11/11 10:10”) is “17” (refer to the first row of FIG. 9) and that the forecast value for the average I/O count every minute in the time zone “2009/11/30 19:00” to “2009/11/40 19:00” for this array group 144 is “30” (refer to the fifth row from the bottom of FIG. 9).

### (5-2) Configuration of the Resource Configuration Information Table Group

An example of the configuration of the resource configuration information table group 203 (FIG. 2) used by the storage management software 154 will be described next with reference to FIGS. 10 to 13.

The resource configuration information table group 203 is configured from the device file/file system-logical volume association table 1000 (FIG. 10), the device file/file system/application association table 1100 (FIG. 11), the logical volume/array group association table 1200 (FIG. 12), and the array group configuration information table 1301 (FIG. 13). These tables are also created on the basis of information collected by the agent information collection unit 201 from the storage monitoring agent 165, the host monitoring agent 125, and the application monitoring agent 123.

The device file/file system-logical volume association table 1000 is a table that is used to manage associations between the device files and file systems of the host servers 101, and the logical volumes 145 defined in the storage apparatuses 103 and, as shown in FIG. 10, is configured from a host server identifier field 1001, a device file identifier field 1002, a file system identifier field 1003, a storage apparatus identifier field 1004, and a logical volume identifier field 1005.

Furthermore, the device file identifier field 1002, the file system identifier field 1003, and the logical volume identifier field 1005 store the identifiers of the device files, file systems, and logical volumes 145 that are associated with the aforementioned fields respectively (linked by lines in FIG. 3). The host server identifier field 1001 stores the host server identifiers of the host servers 101 in which the device files and file systems are provided, and the storage apparatus identifier field 1004 stores storage identifiers of the storage apparatuses 103 in which the logical volumes 145 are created.

Therefore, FIG. 10 shows, for example, that the device file known as “DF A” and the file system known as “FS A” in the host server 101 called “HOST A” are associated with the logical volume 145 called “LDEV A” in the storage apparatus 103 referred to as “ST A.”

In addition, the device file/file system/application association table 1100 is a table that is used to manage associations between device files, file systems, and applications (business operation software 120) in the host servers 101 and, as shown in FIG. 11, is configured from a host server identifier field 1101, a device file identifier field 1102, a file system identifier field 1103, and an application identifier field 1104.

Furthermore, the device file identifier field 1102, the file system identifier field 1103, and the application identifier field 1104 store the respective identifiers of the device files, file systems, and applications associated with the aforementioned fields respectively (linked by lines in FIG. 2). Furthermore, the host server identifier field 1101 stores the host server identifiers of the host servers 101 that comprise these device files, file systems, and applications.

Hence, FIG. 11 shows, for example, that the device file known as “DF A,” the file system known as “FS A,” and the application known as “AP A” in the host server 101 called “HOST A” are associated with one another.

In addition, the logical volume/array group association table 1200 is a table that is used to manage associations between the logical volumes 145 and array groups 144 defined in the storage apparatuses 103 and, as shown in FIG. 12, is configured from a storage apparatus identifier field 1201, a logical volume identifier field 1202, a logical volume defined capacity field 1203, and an array group identifier field 1204.

Further, the logical volume identifier field 1202 stores the logical volume identifiers of each of the logical volumes 145 created in any of the storage apparatuses 103 respectively, and the array group identifier field 1204 stores the array group identifiers of the array groups 144 with which the corresponding logical volumes 145 are associated. Furthermore, the storage apparatus identifier field 1201 stores the storage apparatus identifiers of the storage apparatuses 103 in which the logical volumes 145 have been defined, and the logical volume defined capacity field 1203 stores the defined capacity of the corresponding logical volumes 145.

Hence, FIG. 12 shows, for example, that the logical volume 145 known as “LDEV A” defined in the storage apparatus 103 known as “ST A” has a defined capacity of “250” and is defined in the storage area provided by the memory apparatus 142 belonging to the array group 144 known as “AG A.”

The array group configuration information table 1300 is a table that is used to manage the array groups 144 defined in the storage apparatus 103 and, as shown in FIG. 13, is configured from an array group identifier field 1301, a memory apparatus type field 1302, a memory apparatus count field 1303, an array group actual capacity field 1304, and an array group power consumption amount field 1305.

Furthermore, the array group identifier field 1301 stores the array group identifiers that are assigned to each of the array groups 144 defined in any of the storage apparatuses 103 respectively, and the memory apparatus type field 1302 stores the types of the memory apparatuses 142 configuring the array groups 144.

Furthermore, the memory apparatus count field 1303 stores the numbers of memory apparatuses 142 that belong to the corresponding array groups 144 and the array group actual capacity field 1304 stores the actual overall capacity of the corresponding array groups 144. Additionally, the array group power consumption amount field 1305 stores the overall power consumption amounts of the corresponding array groups 144, which are calculated as will be described subsequently.

Hence, FIG. 13 shows, for example, that the array group 144 known as “AG A” is configured from nine memory apparatuses 142 of the “SATA” memory apparatus type, the actual overall capacity of the array group 144 is “720,” and the overall power consumption amount of the array group 144 is “270.”

### (5-3) Configuration of the Resource Grouping Information Table Group

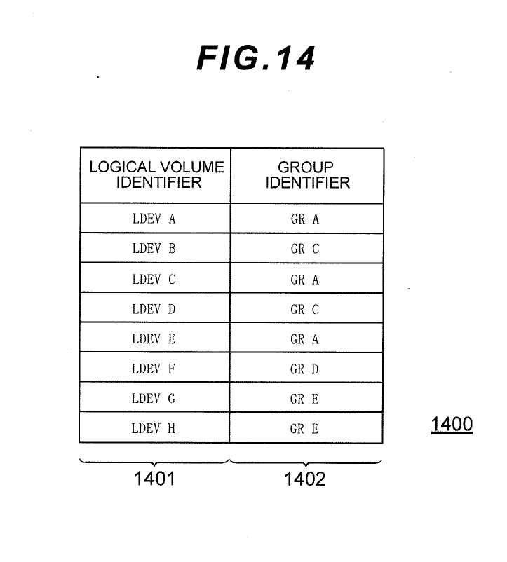

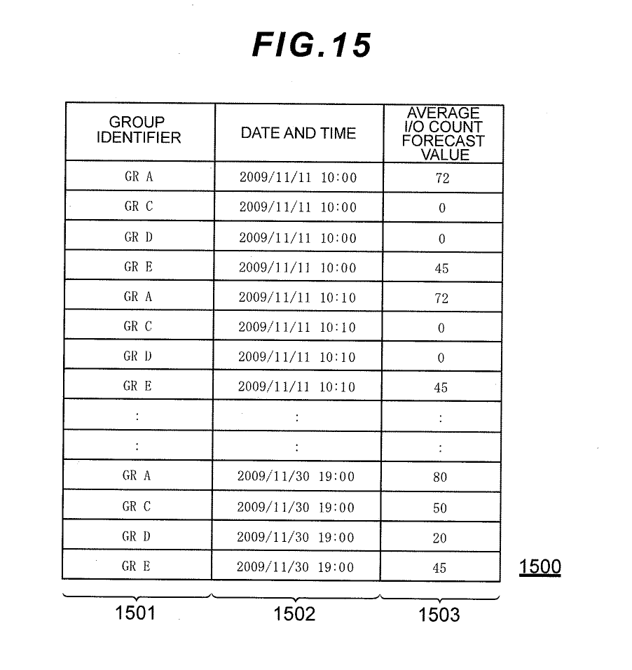

Meanwhile, the resource grouping information table group 205 (FIG. 2) is configured from the resource grouping configuration table 1400 shown in FIG. 14 and the resource grouping performance information table 1500 shown in FIG. 15.

The resource grouping configuration table 1400 is a table that is used to hold and manage information related to the configuration of each group of logical volumes 145 formed by the resource grouping unit 204 (FIG. 2) and, as shown in FIG. 14, is configured from the logical volume identifier field 1401 and the group identifier field 1402.

Furthermore, the logical volume identifier field 1401 stores the respective logical volume identifiers of each of the logical volumes 145 defined in any of the storage apparatuses 103, and the group identifier field 1402 stores the group identifiers of the groups to which the corresponding logical volumes 145 belong.

Hence, FIG. 14 shows that the group known as “GA A” is configured from two logical volumes 145 known as “LDEV A” and “LDEV C”; the group known as “GA B” is configured from a logical volume 145 known as “LDEV E”; the group known as “GA C” is configured from two logical volumes 145 called “LDEV B” and “LDEV D”; the group known as “GA D” is configured from a logical volume 145 called “LDEV F,” and the group known as “GA E” is configured from two logical volumes 145 known as “LDEV G” and “LDEV H.”

Furthermore, the resource grouping performance information table 1500 is a table that is used to hold and manage performance information for each group of logical volumes 145 formed by the resource grouping unit 204 (FIG. 2) and, as shown in FIG. 15, is configured from a group identifier field 1501, a date and time field 1502, and an average I/O count forecast value field 1503.

Furthermore, the group identifier field 1501 stores the respective group identifiers of each group of logical volumes 145, and the date and time field 1502 stores the date and time zone when the information was collected (time zones for every 10 minutes in the example of FIG. 15).

The average I/O count forecast value field 1503 stores a forecast value for the average value of the I/O counts in the corresponding group for every predetermined time (every minute in the example of FIG. 15) in the corresponding time zone. The forecast value is a total value obtained by totaling up the average I/O counts of all the logical volumes 145 belonging to the corresponding groups. Note that hereinafter the forecast value for the average values of the I/O counts for every minute for each group in each time zone will be referred to as the group average I/O count forecast value.

Hence, FIG. 15 shows, for example, that the group average I/O count forecast value for every minute in the group referred to as “GR A” in the time zone “2009/11/11 10:00” to “2009/11/11 10:10” (specifically, the average value of the I/O counts for a total of ten groups acquired every minute in the time zone “2009/11/11 10:00” to “2009/11/11 10:10”) is “17” (refer to the first row in FIG. 15), and that the group average I/O count forecast value for each minute in the time zone “2009/11/30 19:00” to “2009/11/40 19:00” of the group is “80” (refer to the fourth row from the bottom of FIG. 15).

### (5-4) Configuration of Grouping Result Storage Table

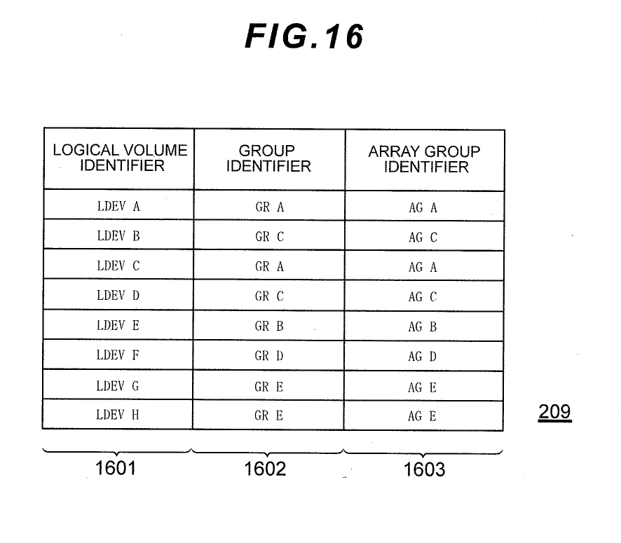

FIG. 16 shows a configuration example of the grouping result storage table 209. The grouping result storage table 209 is a table that is used to hold and manage correspondence relationships between each of the groups of the logical volumes 145 created by the resource grouping unit 204 (FIG. 2) and the array groups 144 and, as shown in FIG. 16, is configured from a logical volume identifier field 1601, a group identifier field 1602, and an array group identifier field 1603.

Furthermore, the logical volume identifier field 1601 and the group identifier field 1602 store the same information as the logical volume identifier field 1401 and the group identifier field 1402 respectively in the resource grouping configuration table 1400 (FIG. 14). Furthermore, the array group identifier field 1603 stores the array group identifiers of the array groups 144 distributed among the corresponding groups.

Hence, FIG. 16 shows, for example, that the group known as “GR A,” which is configured from the logical volume 145 known as “LDEV A” and the logical volume 145 known as “LDEV C” is associated with the array group 144 known as “AG A,” and that the group known as “GR B” configured from the logical volume 145 known as “LDEV E” is associated with the array group 144 known as “AG B.”

### (5-5) Configuration of the Reference Value Storage Table

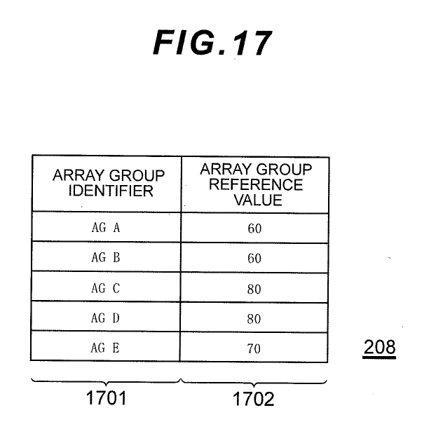

FIG. 17 shows a configuration example of the reference value storage table 208. The reference value storage table 208 is a table that is used to hold and manage the maximum I/O count that satisfies the response time threshold of the corresponding application in the array group 144 and, as shown in FIG. 17, is configured from an array group identifier field 1701 and an array group reference value field 1702.

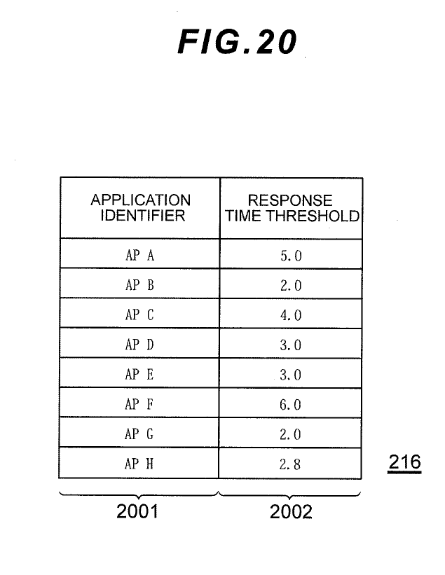

Additionally, the array group identifier field 1701 stores the respective array group identifiers of each of the array groups 144 defined in any of the storage apparatuses 103, and the array group reference value field 1702 stores the maximum value of the average I/O count forecast values (referred to as the array group reference values hereinbelow) that are stored in the corresponding average I/O count forecast value field 903 in the array group performance information table 900 (FIG. 9) within a date and time range in which the maximum mapping time 704 stored in the corresponding maximum response time field 703 in the application performance information table 700 (FIG. 7) is less than the value of the response time threshold stored in the corresponding response time threshold field 2002 in the response time threshold table 216 (FIG. 20) that will be described subsequently.

Hence, FIG. 17 shows, for example, that the array group reference values of the two array groups 144 known as “AG A” and “AG B” are both “60,” the array group reference value of the array group 144 known as “AG E” is “70,” and the array group reference values of the two array groups 144 known as “AG C” and “AG B” are both “80”.

### (5-6) Configuration of the Reduction Rate Storage Table

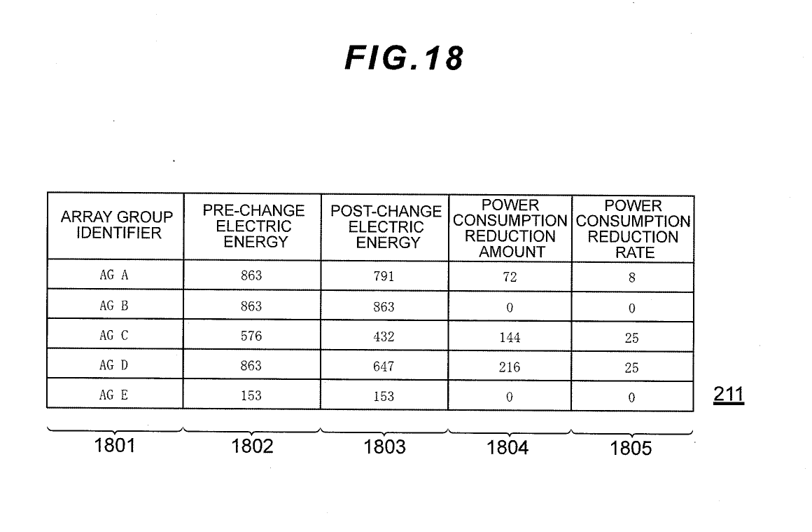

FIG. 18 shows a configuration example of the reduction rate storage table 211. The reduction rate storage table 211 is a table for managing the power consumption amount before-and-after a configuration change for each array group 144 and the power consumption reduction amount and power consumption reduction rate resulting from the configuration change and, as shown in FIG. 18, is configured from an array group identifier field 1801, a pre-change ELECTRIC ENERGY field 1802, a post-change ELECTRIC ENERGY field 1803, a power consumption reduction amount field 1804, and a power consumption reduction rate field 1805.

Furthermore, the array group identifier field 1801 stores the respective array group identifiers of each of the array groups 144 defined in any of the storage apparatuses 103. The pre-change ELECTRIC ENERGY field 1802 stores the power consumption amounts per year prior to the configuration change of the corresponding array groups 144, while the post-change ELECTRIC ENERGY field 1803 stores the power consumption amount following the configuration change per year of the array groups 144.

In addition, the power consumption reduction amount field 1804 stores the power consumption reduction amount per year resulting from a configuration change, and the power consumption reduction rate field 1805 stores the power consumption reduction rate per year resulting from the configuration change.

Hence, in the example of FIG. 18, it can be seen that, for the array group 144 known as “AG A,” the power consumption amount before the configuration change is “863,” the power consumption amount following the configuration change is “791,” the power consumption reduction amount resulting from the configuration change is “72,” and the power consumption reduction rate is “8.”

### (5-7) Configuration of the Power Consumption Reference Value Storage Table

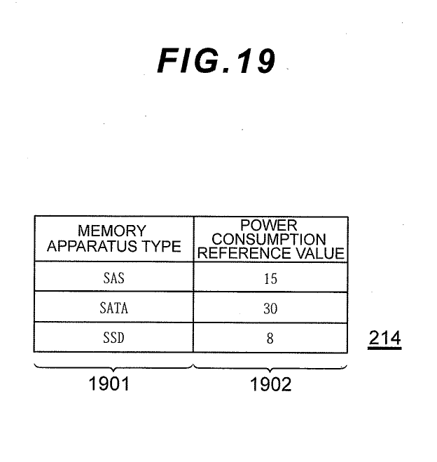

Meanwhile, FIG. 19 shows a configuration example of the power consumption reference value storage table 214. The power consumption reference value storage table 214 is a table that is used to store and manage forecast values for the power consumption per hour for each memory apparatus type that has been configured by the user using the power consumption reference value configuration screen 501 described earlier with reference to FIG. 5 and, as shown in FIG. 19, is configured from a memory apparatus type field 1901 and a power consumption reference value field 1902.

Furthermore, the memory apparatus type field 1901 stores the types of all the memory apparatuses mounted in the storage apparatuses 103 such as “SAS,” “SATA,” and “SSD,” and the power consumption reference value field 1902 stores values configured by the user as the power consumption reference value per hour for the corresponding memory apparatus type.

Hence, the example in FIG. 19 shows that a memory apparatus 142 of the “SAS” memory apparatus type consumes “15 (kW)” of power per hour; a memory apparatus 142 of the “SATA” memory apparatus type consumes “30 (kW)” of power per hour, and the memory apparatus 142 of the “SSD” memory apparatus type consumes 8 (kW)” of power per hour, as configured by the user.

### (5-8) Configuration of Response Time Threshold Table

Meanwhile, FIG. 20 shows a configuration example of the response time threshold table 216. The response time threshold table 216 is a table that is used to store and manage the response time threshold for each application (business operation software 120) that is configured by the user using the response time threshold configuration screen 601 described earlier with respect to FIG. 6 and, as shown in FIG. 20, is configured from an application identifier field 2001 and a response time threshold field 2002.

Furthermore, the application identifier field 2001 stores the application identifiers of each of the applications installed on the host servers 101, and the response time threshold field 2002 stores values set by the user as the response time thresholds for the corresponding applications.

Hence, the example of FIG. 20 shows that the response time threshold for the application known as “AP A” is set at “5.0,” the response time threshold for the application known as “AP B” is set at “2.0,” and the response time threshold of the application known as “AP C” as set at “4.0,” for example.

### (6) Various Processing by the Storage Management Software

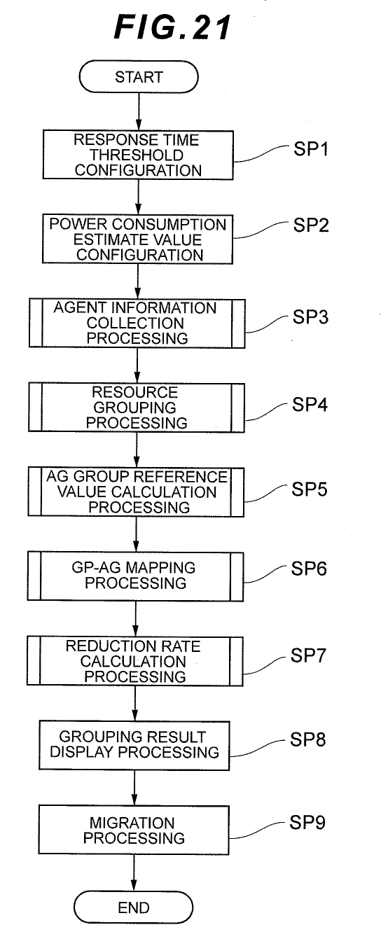

The processing content of various processes executed by each of the program modules in the storage management software 154 will be described next with reference to FIGS. 21 to 28.

### (6-1) Power Saving Processing

FIG. 21 shows the flow of power saving processing that is executed by the storage management software 154. The storage management software 154 executes the power saving processing of this embodiment in accordance with the processing routine shown in FIG. 21.

In other words, in the storage management software 154, the response time threshold for each application configured by the user using the response time threshold configuration screen 601 (FIG. 6) that is displayed on the display device of the storage management client 105 is first configured internally by being stored by the response time threshold configuration unit 217 (FIG. 2) in the response time threshold table 216 (FIG. 2) (SP1).

Thereafter, the power consumption reference value for each memory apparatus type configured by the user using the power consumption reference value configuration screen 501 (FIG. 5) displayed on the display device of the storage management client 105 is configured internally by being stored by the power consumption reference value configuration unit 215 (FIG. 2) in the power consumption reference value storage table 214 (FIG. 2) (SP2).

The agent information collection unit 201 (FIG. 2) collects performance information and configuration information on each resource from the storage monitoring agent 165, the host monitoring agent 125, and the application monitoring agent 123. The agent information collection unit 201 then stores the performance information, from the performance information and configuration information on each resource thus collected, in the application performance information table 700 (FIG. 7), the logical volume performance information table 800 (FIG. 8), and the array group performance information table 900 (FIG. 9) that configure the resource performance information table group 202 (FIG. 2). Furthermore, the agent information collection unit 201 stores the configuration information, from the performance information and the configuration information on each resource thus collected, in the device file/file system-logical volume association table 1000 (FIG. 10), the device file/file system/application association table 1100 (FIG. 11), the logical volume/array group association table 1200 (FIG. 12), and the array group configuration information table 1301 (FIG. 13) (SP3).

Subsequently, the resource grouping unit 204 (FIG. 2) refers to the resource performance information table group 202, groups the logical volumes 145 with overlapping time zones for which the average I/O count is zero in the same group, and stores grouping result-based information in the resource grouping configuration table 1400 (FIG. 14) and the resource grouping performance information table 1500 (FIG. 2) that configure the resource grouping information table group 205 (FIG. 2) (SP4).

Thereafter, the array group reference value calculation unit 207 (FIG. 2) refers to the resource performance information table group 202 and the resource configuration information table group 203, calculates in each case the array group reference values of the respective array groups 144, and stores the respective array group reference values thus calculated in the reference value storage table 208 (FIG. 2) (SP5).

Subsequently, the group/array group mapping unit 206 (FIG. 2) maps the array groups 144 to each of the groups of logical volumes 145 on the basis of each of the information items stored in the resource performance information table group 202, the resource configuration information table group 203, the resource grouping information table group 205, and the reference value storage table 208 (FIG. 2), and stores the results in the grouping result storage table 209 (FIG. 2) (SP6).

Subsequently, the reduction rate calculation unit 210 (FIG. 2) calculates the power consumption reduction amount and power consumption reduction rate as a result of a configuration change on the basis of each of the information items stored in the resource performance information table group 202, the resource configuration information table group 203, the grouping result storage table 209, the power consumption reference value storage table 214, and the reduction rate storage table 211, and stores the power consumption reduction amount and power consumption reduction rate thus calculated in the reduction rate storage table 211 (FIG. 2) (SP7).

Thereafter, the grouping display unit 212 (FIG. 2) displays the grouping result display screen 401 described earlier with reference to FIG. 4 on the storage management client 105 on the basis of each of the information items acquired from the resource performance information table group 202, the resource configuration information table group 203, the grouping result storage table 209, the reduction rate storage table 211, and the response time threshold table 216 (FIG. 2) (SP8).

Subsequently, in the case of manual mode, the migration control unit 213 (FIG. 2) takes a user execution command that is supplied via the grouping display unit 212 as a trigger and, in the case of automatic mode, derives the difference before and after a configuration change on the basis of the grouping result storage table 209 and the resource configuration information table group 203 and, by controlling the migration execution unit 143 of the storage apparatus 103 based on the derived result, migrates data stored in the migration source array group 144 to the migration destination array group 144 (SP9).

The storage management software 154 then terminates the power saving processing.

### (6-2) Agent Information Collection Processing

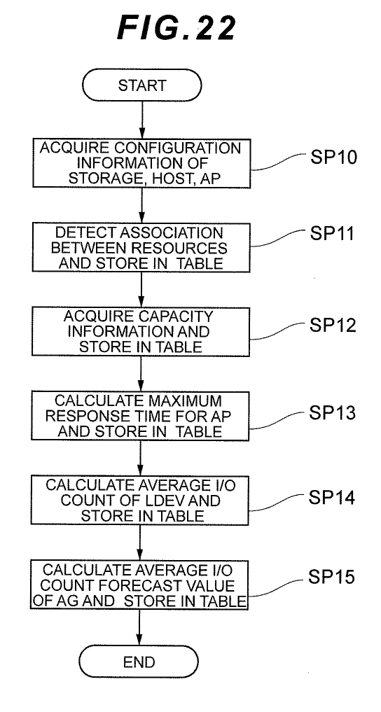

Here, FIG. 22 shows the processing routine for agent information collection processing that is executed by the agent information collection unit 201 (FIG. 2) in step SP3 of the power saving processing described earlier.

The agent information collection unit 201 starts the agent information collection processing shown in FIG. 22 when started up in accordance with a regular startup schedule and first collects the performance information and configuration information on the storage apparatuses 103, the host servers 101, and the applications (business operation software 120) from the storage monitoring agent 165, the host monitoring agent 125, and the application monitoring agent 123 (SP10).

Thereafter, the agent information collection unit 201 derives associations between the hosts servers 101, the applications, the file systems, the device files, the storage apparatuses 103, the logical volumes 145, and the array groups 144 on the basis of the configuration information of the storage apparatuses 103, the host servers 101, and the applications collected in step SP10, and stores the derived result in the device file/file system-logical volume association table 1000 (FIG. 10), the device file/file system/application association table 1100 (FIG. 11), the logical volume/array group association table 1200 (FIG. 12), and the array group configuration information table 1301 (FIG. 13) which are in the resource configuration information table group 203 (SP11).

The agent information collection unit 201 then acquires the defined capacity of each logical volume 145 and the actual amount for each of the array groups 144 respectively from the configuration information of the storage apparatuses 103, the host servers 101 and the applications collected in step SP10. The agent information collection unit 201 subsequently stores the defined capacity of each logical volume 145 thus acquired in the logical volume/array group association table 1200, and stores the acquired actual capacity for each array group 144 in the array group configuration information table 1300 (SP12).

The agent information collection unit 201 then calculates for each application and based on the application performance information collected from the application monitoring agent 123, the respective maximum response time average values, which are the average values of the maximum response times for every predetermined time (one minute) in each predetermined time zone (times zone every 10 minutes), and stores the calculation result in the application performance information table 700 of the resource performance information table group 202 (FIG. 7) (SP13).

In addition, the agent information collection unit 201 calculates, for each logical volume 145 and on the basis of the performance information of the logical volumes 145 collected from the storage monitoring agent 165, the average I/O count in each case, which is the average value of the I/O counts of the logical volumes 145 for each predetermined time (one minute) in predetermined time zones (time zones for every 10 minutes), and stores the calculated result in the logical volume performance information table 800 (FIG. 8) of the resource performance information table group 202 (SP14).

Thereafter, the agent information collection unit 201 calculates as an average I/O count forecast value the total value of the average I/O count of each of the logical volumes 145 associated with the array groups 144 in each predetermined time zone (time zones for every 10 minutes), for each array group 144 and based on the average I/O count for each predetermined time (one minute) and for each logical volume 145 stored in the logical volume performance information table 800 in step SP14, and on information representing associations between each of the logical volumes 145 and array groups 144 stored in the logical volume/array group association table 1200 in step SP11, and stores the calculation result in the array group performance information table 900 (SP15).

The agent information collection unit 201 then terminates the agent information collection processing.

### (6-3) Resource Grouping Processing

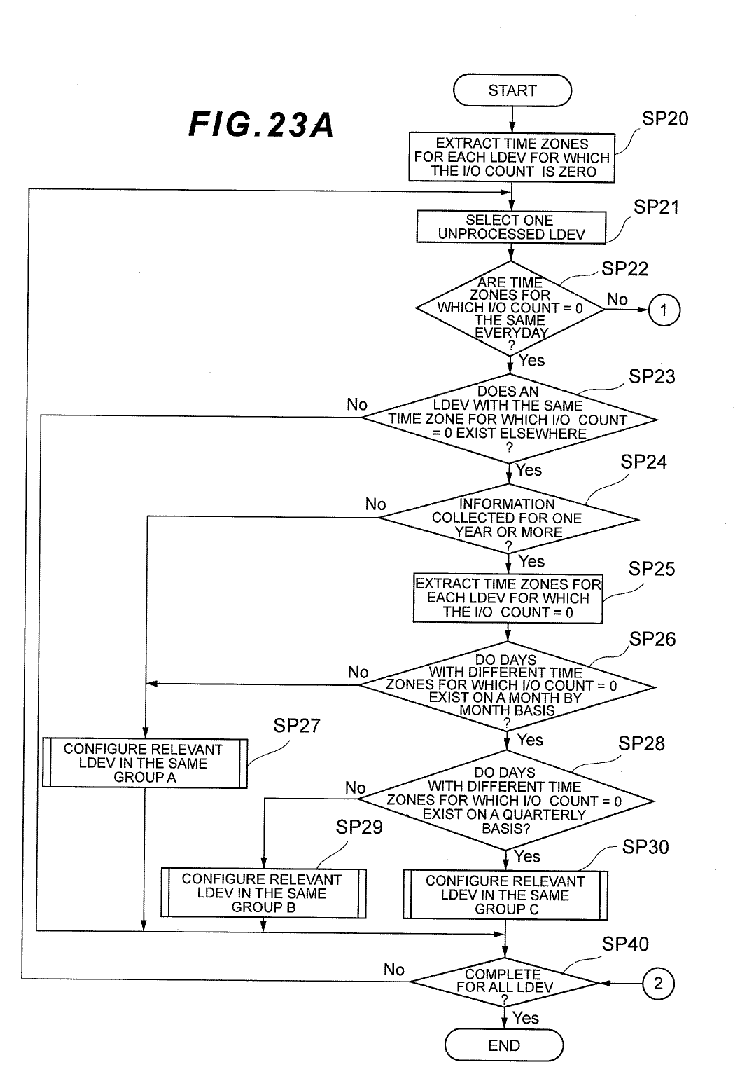

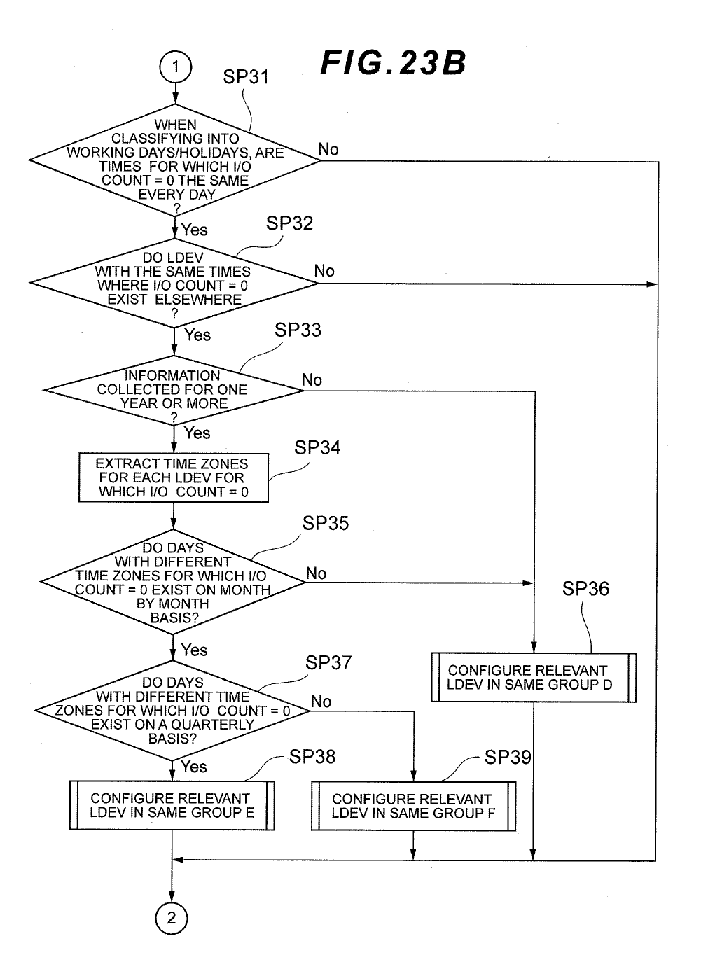

Meanwhile, FIGS. 23A and 23B show a processing routine for resource grouping processing executed by the resource grouping unit 204 (FIG. 2) in step SP4 of the power saving processing mentioned earlier.

The resource grouping unit 204 is started up at regular intervals by scheduling settings, for example. At startup, the resource grouping unit 204 starts the resource grouping processing shown in FIGS. 23A and 23B, and first extracts all the time zones for which the average I/O count is zero for each logical volume 145, on the basis of the average I/O count in each predetermined time zone (time zones for every 10 minutes) of each of the logical volumes 145 corresponding to the most recent single week registered in the logical volume performance information table 800 (FIG. 8) (SP20).

The resource grouping unit 204 then selects one of the unprocessed logical volumes 145 for which the processing (described subsequently) of steps SP22 to SP39 has not yet been executed or which has not yet been allocated to any group (SP21).

The resource grouping unit 204 then determines whether time zones for which the average I/O count is “0” are the same every day for the logical volume 145 selected in step SP21 (SP22). When this determination yields an affirmative result, the resource grouping unit 204 determines whether logical volumes 145 with the same time zone with an average I/O count of “0” exist elsewhere (SP23).

The resource grouping unit 204 proceeds to step SP40 when this determination yields a negative result. However, when the determination yields an affirmative result, the resource grouping unit 204 determines whether or not there is one year or more worth of performance information for the logical volumes 145 stored in the logical volume performance information table 800 (FIG. 8) (SP24).

When this determination yields a negative result, the resource grouping unit 204 then proceeds to step SP27. However, when this determination yields a positive result, the resource grouping unit 204 extracts, for the logical volume 145 selected in step SP21 and all the other logical volumes 145 detected in step SP21, all time zones for which the average I/O count is “0” on the basis of the performance information for the logical volumes 145 for the preceding week stored in the logical volume performance information table 800 (SP25).

The resource grouping unit 204 subsequently determines, based on the processing result of step SP25 and for the logical volume 145 selected in step SP21 and all the other logical volumes 145 detected in step SP23, whether or not, on a month by month basis, there are days with different time zones for which the average I/O count is “0” for one to several days or so (SP26).

When this determination yields a negative result, the resource grouping unit 204 subsequently configures the logical volume 145 selected in step SP21 and all the other logical volumes 145 extracted in step SP23 in the same group (SP27). Specifically, the resource grouping unit 204 stores the same unique group identifier in each of the group identifier fields 1402 (FIG. 14) that each correspond to these logical volumes 145 respectively in the resource grouping configuration table 1400 (FIG. 14). The resource grouping unit 204 then proceeds to step SP40.

However, when the determination of step SP26 yields of an affirmative result, the resource grouping unit 204 determines, for the logical volume 145 selected in step SP21 and all the other logical volumes 145 extracted in step SP23, whether or not on a quarterly basis there are days with different time zones for which the average I/O count is “0” for one to several days or so (SP28).

When the determination of step SP28 subsequently yields a negative result, the resource grouping unit 204 configures, similarly to step SP27, the logical volume 145 selected in step SP21 and all the logical volumes 145 extracted in step SP23 into the same group (SP29).

Furthermore, when the determination of step SP28 yields an affirmative result, the resource grouping unit 204 configures, similarly to step SP27, the logical volume 145 selected in step SP21 and all the other logical volumes 145 extracted in step SP23 into the same group (SP30).

However, when the determination of step SP22 yields a negative result, the resource grouping unit 204 determines, for the logical volume 145 selected in step SP21, whether or not the time zones for which the average I/O count is zero are the same every day (SP31). Specifically, the resource grouping unit 204 determines in step SP31 whether or not there are overlapping time zones for which the average I/O count is “0” if, for example, time zones with an average I/O count of “0” are different on Sunday and Monday but there are overlapping time zones with an average I/O count of “0” if Sundays and Saturdays are compared from week to week. When this determination yields a negative result, the resource grouping unit 204 then proceeds to step SP40.

However, when the determination of step SP31 yields an affirmative result, the resource grouping unit 204 then executes the steps SP32 to SP39 in the same way as steps SP23 to SP30.

When before long the execution of the processing of steps SP36, SP38, or SP39 is complete, the resource grouping unit 204 proceeds to step SP40 and determines whether or not the execution of the processing of steps SP22 to SP39 is complete for all the logical volumes 145 defined in any of the storage apparatuses 103 (SP40).

The resource grouping unit 204 returns to step SP21 when this determination yields a negative result, and then repeats the processing of steps SP21 to SP40.

When before long an affirmative result is obtained in step SP40 as a result of terminating execution of the processing steps SP22 to SP39 for all the logical volumes 145, the resource grouping unit 204 terminates the resource grouping processing.

### (6-4) Array Group Reference Value Calculation Processing

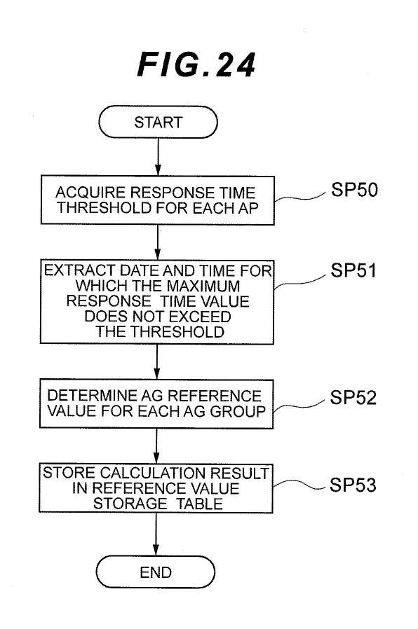

FIG. 24 shows the processing routine for the array group reference value calculation processing that is executed by the array group reference value calculation unit 207 (FIG. 2) in step SP5 of the power saving processing described earlier.

When the resource performance information table group 202 and/or the resource configuration information table group 203 is updated by the agent information collection unit 201, the array group reference value calculation unit 207 starts the array group reference value calculation processing shown in FIG. 24, and first acquires the response time threshold of each application (business operation software 120) from the response time threshold table 216 (FIG. 20) (SP50).

The array group reference value calculation unit 207 then extracts, for each application, the days and time zones for which the maximum response time does not exceed the response time threshold of the application from the application performance information table 700 (FIG. 7) (SP51).

The array group reference value calculation unit 207 then detects, for each application, the date and time for which the average I/O forecast value of the application stored in the array group performance information table 900 (FIG. 9) is maximum from the days and time zones acquired in step SP51, and determines the average I/O forecast value of the application on that date and time as the array group reference value for that array group 144 (SP52).

In addition, the array group reference value calculation unit 207 stores the array group reference value for each array group 144 determined in step SP42 in the reference value storage table 208 (FIG. 17)-(SP53), and then terminates the array group reference value calculation processing.

### (6-5) Group-Array Group Mapping Processing

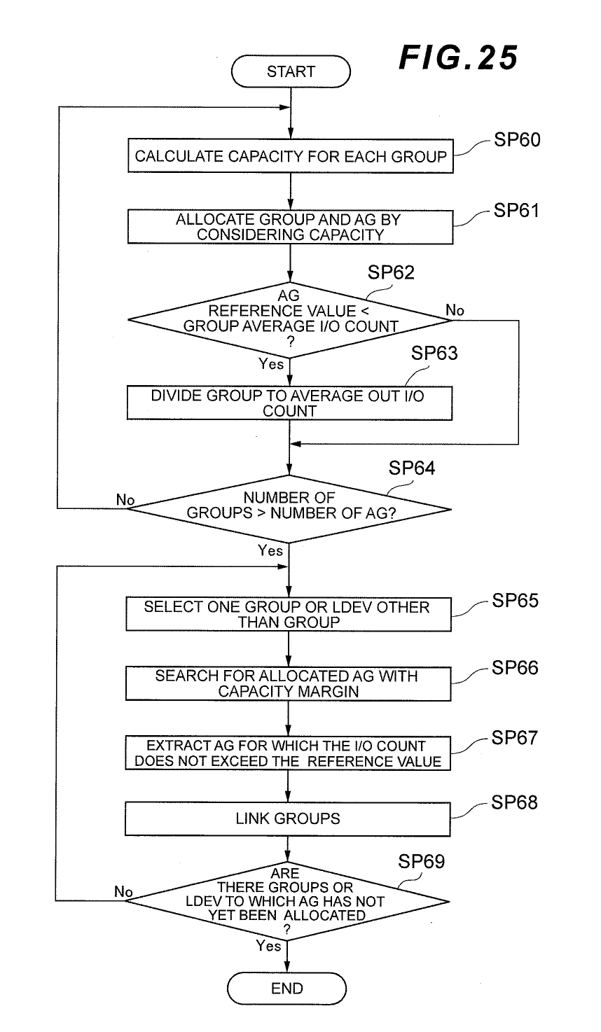

FIG. 25 shows the processing routine for group/array group mapping processing that is executed by the group/array group mapping unit 206 (FIG. 2) in step SP6 of the power saving processing described earlier. The group/array group mapping unit 206 executes, at irregular intervals, group/array group mapping processing to map the array groups 144 to each of the groups of logical volumes 145 created by the resource grouping unit 204 in accordance with the processing routine shown in FIG. 25.

In other words, once started up, the group/array group mapping unit 206 starts the group/array group mapping processing shown in FIG. 24, and first calculates in each case the capacity of each group created by the resource grouping unit 204 (SP60). Specifically, the group/array group mapping unit 206 calculates, for each group of logical volumes 145, the capacity of the groups by adding together defined capacities of the logical volumes 145 configuring the groups on the basis of the resource grouping configuration table 1400 (FIG. 14) of the resource grouping information table group 205 (FIG. 2), and a logical volume array group association table 1200 (FIG. 12) of the resource configuration information table group 203.

The group/array group mapping unit 206 then refers to the array group configuration information table 1300 (FIG. 13) of the resource configuration information table group 203 and allocates array groups 144 with a large actual capacity in order starting with the group with the largest capacity to each of the groups of logical volumes 145 respectively (SP61). At this time, if the capacity of a single group is lacking by an amount corresponding to the actual capacity of a single array group 144, the group/array group mapping unit 206 allocates an array group 144 with a capacity that covers the difference to the group.

The group/array group mapping unit 206 refers to the resource grouping performance information table 1500 (FIG. 15) and the reference value storage table 208 (FIG. 17), and determines whether or not, among the groups of logical volumes 145 to which an array group was, allocated in step SP61, there is a group with a larger average I/O count forecast value than the array group reference value of the array group 144 allocated to that group (SP62).

The group/array group mapping unit 206 proceeds to step SP64 when this determination yields a negative result, but when an affirmative result is obtained, the group/array group mapping unit 206 performs group division by focusing on the time zone with the largest I/O count and balancing the I/O counts for that time zone for each group of logical volumes 145 detected in step SP62 and which has a larger average I/O count forecast value than the array group reference value of the allocated array group 144 (divides the logical volumes 145 configuring the group into two or more groups) (SP63).

Thereafter, the group/array group mapping unit 206 determines whether or not the number of groups of logical volumes 145 is greater than the number of array groups 144 (SP64). The group/array group mapping unit 206 subsequently returns to step SP60 when this determination yields a negative result, and then repeats the processing of steps SP60 to SP64.

When before long an affirmative result is obtained in step SP64 as a result of the number of groups of logical volumes 145 exceeding the number of array groups 144, the group/array group mapping unit 206 selects one group or logical volume 145 with the greatest capacity among the groups of logical volumes 145 to which an array group 144 has not yet been allocated and the logical volumes 145 to which an array group 144 has not yet been allocated and which do not belong to any group (SP65).

The group/array group mapping unit 206 then refers to the array group configuration information table 1300 and searches, among the array groups 144 already allocated to either a group or logical volume 145, array groups 144 for which the difference between the actual capacity of the array group 144 and the total capacity of the group and/or logical volume 145 allocated to that array group 144 is greater than the capacity of the group or logical volume 145 selected in step SP65 (SP66).

The group/array group mapping unit 206 then extracts, among the array groups 144 retrieved in step SP66, array groups 144 for which a value does not exceed the array group reference value of the array group 144, this value being obtained by totaling up the total value of average I/O count forecast values of groups and the like already allocated to the array group 144 (groups and/or logical volumes 145 that do not belong to any group) and the average I/O count forecast value or average I/O count of the group or logical volume 145 selected in step SP65 (SP67).

In addition, the group/array group mapping unit 206 selects a relevant group or the like from among the groups and so on already allocated to the array groups 144 extracted in step SP67, and links this group or the like to the group or the like selected in step SP65 as a single group (SP68).

The group/array group mapping unit 206 then determines whether or not there is a group to which an array group 144 has not yet been allocated or a logical volume 145 to which an array group has not been allocated and that does not belong to any group (SP69).

The group/array group mapping unit 206 returns to step SP65 when this determination yields a negative result and then repeats the processing of steps SP65 to SP69.

The group/array group mapping unit 206 terminates the group/array group mapping processing when before long an affirmative result is obtained in step SP69 as a result of completion of the allocation of array groups to all groups and all the logical volumes 145 that do not belong to any group.

Note that, in step SP68, the following method can be adopted as the method for selecting the group or the like to be linked to the group or the like selected in step SP65 from among the groups and so on already allocated to the array groups 144 extracted in step SP67. In the following description, the group or the like selected in step SP65 will be referred to as “group A” and the one or plurality of groups or the like already allocated to the array groups 144 extracted in step SP67 will be referred to as “groups B.”

Foremost, groups with a large time zone overlap with group A and for which the I/O count is “0” are extracted from groups B.

Specifically, each time zone (time zones for every 10 minutes, for example) is divided into a plurality of sections of equal length and, for each section, determination is made of whether there is I/O with respect to groups A and B. in the section. Thereafter, “1” is allocated to those sections if there is I/O with respect to both groups A and B, and if there is no I/O with respect to either group A or B, and “0” is allocated to those sections if there is I/O with respect to both groups A and B and if there is I/O with respect to only either one of groups A and B. The number n of sections to which “1” is allocated is divided by the total number N of sections. The larger the number of groups B with a division result (n/N) close to 1, the greater the overlap with group A of time zones with an I/O count of “0.”

Thereafter, from among groups B for which there is a large overlap with group A of time zones with an I/O count of “0” (no less than the threshold, for example), a group or the like is selected which has an average I/O count in each time zone when the I/O with respect to group A and the I/O with respect to groups B are combined.

Specifically, if we let the I/O amount of group A in each section in a certain time zone be Xi (i=1, 2, . . . N) and let the I/O amount of group B in each section in the same time zone be Yi (i=1, 2, . . . N), a correlation between a data string {Xi} and a data string {Yi} is found, and a group or the like for which a correlation K is closest to “−1” (negative correlation) is selected from among groups B for which there is a large overlap with group A of time zones with an I/O count of “0.” This is because the closer the correlation K is to “−1,” the smaller the I/O of the groups B in the sections with a large group A I/O; hence, adding together the I/O amounts of groups A and B in the respective sections has the effect of balancing the totals of the overall I/O amounts across the whole time zone. Here, the sections for which the I/O amounts of groups A and B are both “0” are excluded from the data string targets for calculating this correlation.

### (6-6) Reduction Rate Calculation Processing

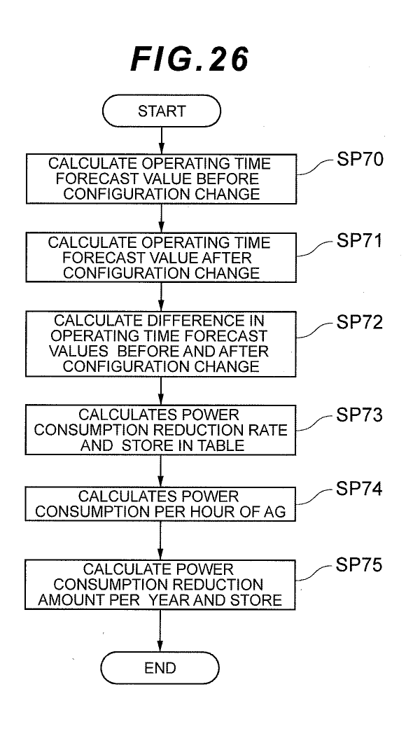

FIG. 26 shows the processing routine for reduction rate calculation processing that is executed by the reduction rate calculation unit 210 (FIG. 2) in step SP7 of the power saving processing described earlier. When the grouping result storage table 209 is updated by the group/array group mapping unit 206, the reduction rate calculation unit 210 calculates the power consumption amount before and after a configuration change for each array group 144 and the power consumption reduction amount and power consumption reduction rate in accordance with the processing routine shown in FIG. 26.

In other words, when the grouping result storage table 209 is updated by the group/array group mapping unit 206, the reduction rate calculation unit 210 starts the reduction rate calculation processing, first referring to the array group performance information table 900 (FIG. 9) and, for each array group 144, calculates a forecast value for the operating time before the configuration change (called the operating time forecast value hereinbelow) (SP70).

The reduction rate calculation unit 210 then acquires information indicating the association between array groups 144 and logical volumes 145 after the configuration change from the grouping result storage table 209 (FIG. 16) and, by using the acquired information, refers to the average I/O count for each logical volume 145 in each time zone stored in the logical volume performance information table 800 (FIG. 8) and calculates an operating time forecast value for each array group 144 after the configuration change (SP71).

The reduction rate calculation unit 210 then calculates the difference in the operating time forecast values before and after the configuration change for each array group 144 (SP72). The reduction rate calculation unit 210 also uses the difference in operating time forecast values before and after the configuration change for each array group 144 obtained in step SP72 to calculate, for each of the array groups 144, the power consumption reduction rate before and after the configuration change, and stores the calculation results in the reduction rate storage table 211 (SP73).

The reduction rate calculation unit 210 then acquires, for each array group 144, the type and number of memory apparatuses 142 (FIG. 1) configuring the array group 144 from the array group configuration information table 1300 (FIG. 13), acquires the power consumption amount per hour for each type of memory apparatus 142 from the power consumption reference value storage table 214 (FIG. 19) and, based on this information, calculates the power consumption amount per hour for each of the array groups 144 (SP74).

The reduction rate calculation unit 210 then calculates, for each array group 144, the power consumption amount before and after the configuration change and the power consumption reduction amount for the array groups 144 respectively based on the operating time forecast value per year for each array group 144 before the configuration change obtained in step SP70, the operating time forecast value per year of each array group 144 after the configuration change obtained in step SP71, and a power consumption amount per hour of each array group 144 obtained in step SP74, and stores the calculation results in the reduction rate storage table 211 (FIG. 18) (SP75). The reduction rate calculation unit 210 then ends the reduction rate calculation processing.

### (6-7) Grouping Display Processing

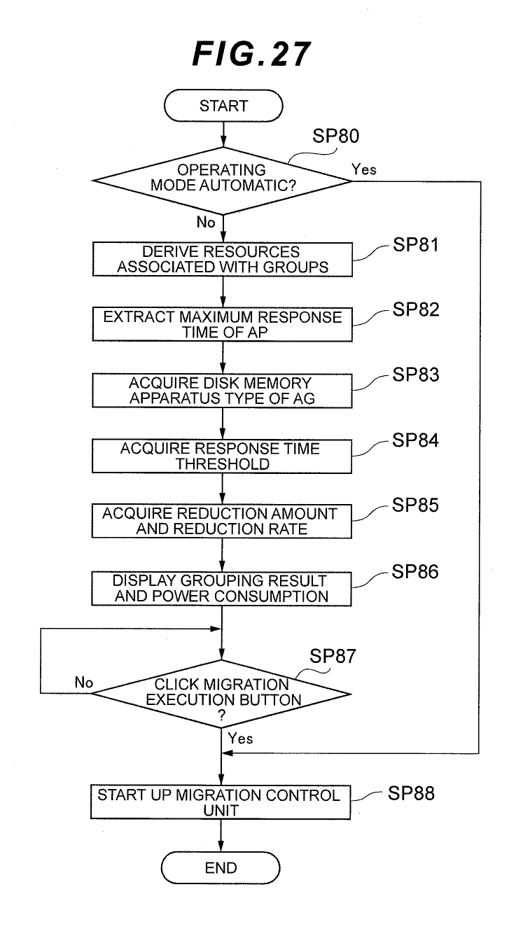

FIG. 27 shows the processing routine for grouping display processing that is executed by the grouping display unit 212 (FIG. 2) in step SP8 of the power savings processing described earlier.

The grouping display unit 212 starts grouping display processing shown in FIG. 27 when the grouping result storage table 209 is updated by the group/array group mapping unit 206, and first determines whether or not the preset operating mode is automatic (SP80). The grouping display unit 212 proceeds to step SP88 when this determination yields an affirmative result.

However, when the determination of step SP80 yields a negative result, the grouping display unit 212 derives, for each group following the configuration change, the device files, file systems, applications, logical volumes 145, and array groups 144 associated with the groups on the basis of the device file/file system-logical volume association table 1000 (FIG. 10), the device file/file system/application association table 1100 (FIG. 11), and the grouping result storage table 209 (FIG. 16) (SP81).

The grouping display unit 212 then refers to the application performance information table 700 (FIG. 7) and, for each application derived in step SP81, extracts the maximum value among the maximum response times of each of the time zones of the application (SP82).

The grouping display unit 212 then refers to the array group configuration information table 1300 (FIG. 13) and, for each array group 144 derived in step SP81, acquires the types of the memory apparatuses 142 that configure the array group 144 (SP83).

In addition, the grouping display unit 212 refers to the response time threshold table 216 (FIG. 20) and, for each application derived in step SP81, acquires the response time threshold of the application (SP84).

The grouping display unit 212 then refers to the reduction rate storage table 211 (FIG. 18) and, for each array group 144 derived in step SP81, acquires the power consumption reduction amount and the power consumption reduction rate of the array group 144 resulting from the configuration change (SP85).

The grouping display unit 212 subsequently generates screen data of the grouping result display screen 401 (FIG. 4) displaying each of the information items acquired in steps SP81 to SP85 and sends the screen data to the storage management client 105. As a result, this grouping result display screen 401 is displayed on the storage management/client 105 on the basis of the screen data (SP86).

The grouping display unit 212 then waits for clicking of the migration execution button 403 (FIG. 4) of the grouping result display screen 401 (SP87). When before long the migration execution button 403 is clicked, the grouping display unit 212 then starts up the migration control unit 213 (SP88) and then ends the grouping display processing.

### (6-8) Migration Control Processing

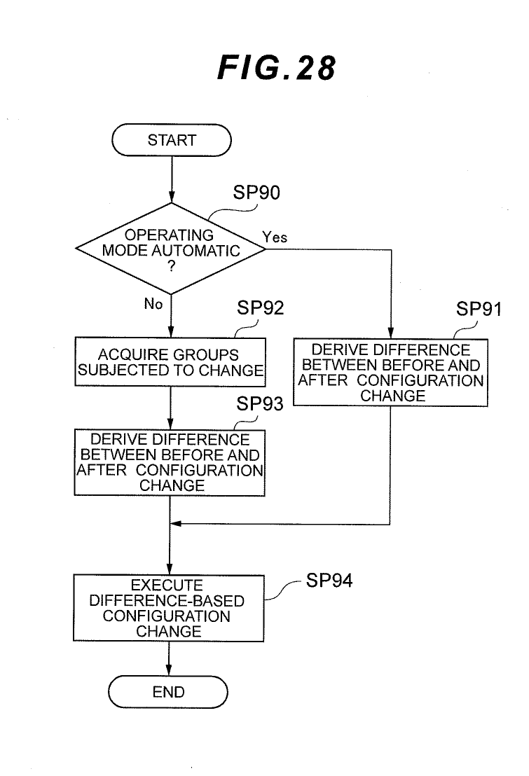

Meanwhile, FIG. 28 shows the processing routine for migration control processing that is executed by the migration control unit 213 (FIG. 2) in step SP9 of the power saving processing described earlier.

Once started up by the grouping display unit 212, the migration control unit 213 starts the migration control processing shown in FIG. 28, and first determines whether or not the preset operating mode is “automatic” (SP90).

When this determination yields an affirmative result, the migration control unit 213 refers to the logical volume/array group association table 1200 (FIG. 12) and the grouping result storage table 209 (FIG. 16) to derive the difference in configurations before and after the configuration change (SP91) and then proceeds to step SP84.

However, when the determination of step SP90 yields a negative result, the migration control unit 213 acquires the group identifier of each group subject to the configuration change from the grouping display unit 212 (SP92), and derives, in each case, the difference in configurations before and after a configuration change for each group subject to the configuration change on the basis of the acquired group identifier and the logical volume/array group association table 1200 (FIG. 12) (SP93).

The migration control unit 213 then controls the storage apparatuses 103 so that the storage apparatuses 103 migrate, to the corresponding array group 144 following the configuration change, the data stored in the corresponding array group 144 before the configuration change on the basis of the difference in configurations before and after the configuration change for each group subject to the configuration change derived in step SP91 or step SP93 (SP94).

The migration control unit 213 then ends the migration control processing.

### (7) Effect of Embodiment

As described earlier, in the computer system 100 according to this embodiment, when the logical volumes 145 defined in the storage apparatuses 103 are grouped, these resources can be grouped to the extent that there is no bottleneck affecting the response performance because the I/O count of each logical volume 145 is also considered. A reliable computer system that enables power savings for storage apparatuses while preventing a drop in response performance can accordingly be realized.

Furthermore, in the computer system 100 of this embodiment, the amount of power that can be reduced by a new grouping (configuration change) of the logical volumes 145 is presented to the user as a grouping result display screen 401, and therefore the user is aware of the trade-off with power consumption if the configuration of the devices coupled to an application with an undesirable load is changed.

### (8) Further Embodiments

Note that although the embodiment hereinabove described a case where, in step SP61 of the group/array group mapping processing mentioned earlier with respect to FIG. 25, the group/array group mapping unit 206 allocates array groups 144 with a large actual capacity to each group of logical volumes 145 in order starting with the group with the largest capacity, the present invention is not limited to this case. For example, groups configured from power saving memory apparatuses 142 may also be mapped to groups with a long operating time or array groups 144 configured from high-performance memory apparatuses 142 may also be mapped to groups with a large I/O count, for example.

Moreover, although the foregoing embodiment described a case where any of the groups are continually divided without paying attention to the I/O count of the group of logical volumes 145 until the number of groups of logical volumes 145 exceeds the number of array groups in the group/array group mapping processing mentioned earlier with respect to FIG. 25, the present invention is not limited to this case. If the number of groups of logical volumes 145 is less than the number of array groups, any groups may be divided as mentioned earlier only in the case of groups where the total value of the I/O counts of the groups of logical volumes is equal to or greater than the reference value, or those groups for which the total value is less than the reference value may be divided.

Moreover, the foregoing embodiment described a case where there is no synergy between the application response time and the array group reference value of the array group 144, but the present invention is not limited to such an arrangement. The array group reference value of the corresponding array group 144 may be lowered and mapping of the logical volumes 145 and array groups 144 may be performed once again if the application response time exceeds the response time threshold configured by the user for the application, for example.

Moreover, although the foregoing embodiment described a case where resources of the same type with which time zones with zero access by the host apparatus occur periodically used for the logical volumes 145 and memory apparatus groups serve as the array groups 144, the present invention is not limited to such an arrangement. Resources of the same type other than the logical volumes 145 may also be adopted and the memory apparatus group may be an entity other than the array group 144; hence, the present invention has a wide range of possible applications.

The present invention is widely applicable to a management apparatus for managing power savings for storage apparatuses in a computer system that comprises host servers and storage apparatuses.

What is claimed is:

1. A management apparatus for managing storage apparatuses which are equipped with a plurality of memory apparatus groups each configured from one or more memory apparatuses of the same type, which provide a storage area supplied by the memory apparatus groups to a host apparatus and which, when the storage area supplied by the memory apparatus groups is not accessed by the host apparatus for a predetermined period, stop operation of each of the memory apparatuses configuring the memory apparatus groups, comprising:
an information collection unit for collecting information indicating a number of accesses, in each predetermined time zone, to each of a plurality of resources of the same type each having a periodic time zone in which the number of accesses by the host apparatus is zero, a response time in each of the time zones by the resources to an application installed on the host apparatus, and an association between the application and the resource;
a grouping unit for grouping, among the resources, resources with overlapping time zones for which the number of accesses by the application is zero, in the same group;
a mapping unit for mapping each of the groups to the memory apparatus groups, respectively;
a migration execution unit for controlling the storage apparatuses to migrate data between memory apparatus groups where necessary on the basis of the result of the mapping of the groups to the memory apparatus groups by the mapping unit; and
a reference value calculation unit for configuring, for each of the memory apparatus groups, a maximum value for the number of accesses by the application to the resources mapped to the memory apparatus groups as a reference value of the memory apparatuses, on the basis of the number of accesses in each time zone by the application to each of the resources collected by the information collection unit, and a response time for each time zone for the response by the resources to the application,
wherein, if the number of accesses in each of the time zones of the groups of resources mapped to the memory apparatus groups exceeds the reference value of the memory apparatus groups, the mapping unit divides the group into a plurality of groups and maps each of the plurality of groups to the memory apparatus groups.

2. The management apparatus according to claim 1, further comprising:
a grouping display unit for displaying electric energy that can be reduced by configuring each of the groups.

3. The management apparatus according to claim 1,
wherein the resources of the same type are logical volumes, and
wherein the mapping unit maps each of the groups to the memory apparatus groups respectively on the basis of the capacity of each group and the capacity of the memory apparatus groups.

4. The management apparatus according to claim 1,
wherein the reference value calculation unit calculates the maximum value for the number of accesses for each time zone within a period in which the response time for a response by the resources to the application does not exceed a preset threshold for the application, and configures the calculated maximum value for the number of accesses as a reference value of the memory apparatuses.

5. The management apparatus according to claim 1,
wherein, if the number of accesses in each of the time zones of the groups of resources mapped to the memory apparatus groups exceeds the reference value of the memory apparatus groups, the mapping unit divides the group into a plurality of groups to balance the number of accesses in the time zones with the largest number of accesses.

6. A management method for managing storage apparatuses which are equipped with a plurality of memory apparatus groups each configured from one or more memory apparatuses of the same type, which provide a storage area supplied by the memory apparatus groups to a host apparatus and which, when the storage area supplied by the memory apparatus groups is not accessed by the host apparatus for a predetermined period, stop operation of each of the memory apparatuses configuring the memory apparatus groups, comprising:
a first step of collecting information indicating a number of accesses, in each predetermined time zone, to each of a plurality of resources of the same type each having a periodic time zone in which the number of accesses by the host apparatus is zero, a response time in each of the time zones by the resources to an application installed on the host apparatus, and an association between the application and the resource;
a second step of configuring, for each of the memory apparatus groups, a maximum value for the number of accesses by the application to the resources mapped to the memory apparatus groups as a reference value of the memory apparatuses, on the basis of the number of accesses in each time zone by the application to each of the collected resources, and a response time for each time zone for the response by the resources to the application, and of grouping, among the resources, resources with overlapping time zones for which the number of accesses by the application is zero, in the same group;
a third step of mapping each of the groups to the memory apparatus groups respectively; and
a fourth step of controlling the storage apparatuses to migrate data between memory apparatus groups where necessary on the basis of the result of the mapping of the groups to the memory apparatus groups,
wherein, in the third step, if the number of accesses in each of the time zones of the groups of resources mapped to the memory apparatus groups exceeds the reference value of the memory apparatus groups, the group is divided into a plurality of groups and each of the plurality of groups is mapped to the memory apparatus groups.

7. The management method according to claim 6,
wherein, in the second step, electric energy that can be reduced by configuring each of the groups is displayed.

8. The management method according to claim 6,
wherein the resources of the same type are logical volumes, and
wherein, in the third step, each of the groups is mapped to the memory apparatus groups respectively on the basis of the capacity of each group and the capacity of the memory apparatus groups.

9. The management method according to claim 6,
wherein, in the second step, the maximum value is calculated for the number of accesses for each time zone within a period in which the response time for a response by the resources to the application does not exceed a preset threshold for the application, and the calculated maximum value for the number of accesses is configured as a reference value of the memory apparatuses.

10. The management method according to claim 6,
wherein, in the third step, if the number of accesses in each of the time zones of the groups of resources mapped to the memory apparatus groups exceeds the reference value of the memory apparatus groups, the group is divided into a plurality of groups to balance the number of accesses in the time zones with the largest number of accesses.
